(19) United States
(12) Patent Application Publication
(10) Pub. No.: US 2014/0100989 A1
(43) Pub. Date: Apr. 10, 2014

(54) SYSTEMS AND METHODS FOR DEETERMINING A FAIR PRICE RANGE FOR COMMODITIES

(71) Applicants: HAN ZHANG, Sydney (AU); WARWICK MIRZIKINIAN, Beverley Hills, CA (US)

(72) Inventors: HAN ZHANG, Sydney (AU); WARWICK MIRZIKINIAN, Beverley Hills, CA (US)

(73) Assignee: VALUERZ, INC., Glendale, CA (US)

(21) Appl. No.: 14/045,495

(22) Filed: Oct. 3, 2013

Related U.S. Application Data
(60) Provisional application No. 61/709,729, filed on Oct. 4, 2012.

(51) Int. Cl. G06Q 30/02

(52) U.S. Cl. CPC G06Q 30/0283
USPC 705/26.61

(57) ABSTRACT

A system and method for determining cross-market correlation factors which contribute to a response to a user request for a price. The system includes a database of plurality of commodities. The system includes a factor determination unit that, responsive to a user request, identifies inter-market and intra-market factors which contribute to a price determination for nearly all of the commodities. The system includes an evaluation unit that, responsive to the user request, evaluates the contribution of each of the inter-market and intra-market factors to identify candidate factors in a model of the commodity for which a price is requested. The system further includes a price response unit that responds to the request with a price for the asset, good or service based on the model. The system and method predict the price based on factors across multiple markets.

### CROSS REFERENCE TO RELATED APPLICATION

The present application claims the benefit of priority under 35 U.S.C. §119(e) to provisional U.S. Application No. 61/709,729, filed on Oct. 4, 2012, the entire contents of which are incorporated by reference herein.

### BACKGROUND

1. Field

The present disclosure relates to pricing system that, responsive to a user request, provides an estimate of a fair price or a fair price range for a commodity, such as an asset, good or service.

2. Description of Related Art

Information asymmetry is pervasive in many real life markets, ranging from real estate, antiquities and collectables to hotels, plane tickets, coffees and sandwiches. This will inevitably put the buyer at a weaker bargaining position, and hence lower the overall market efficiency. Pricing systems exist, particularly web-interfaced pricing systems, but such systems are typically able to provide a price estimate for only a singular item tracked in a database, and/or a price estimate based only on one or a few predictors that are selected manually.

### SUMMARY

This disclosure provides a tool for a buyer to obtain an independent and objective opinion on the price of a commodity. As used throughout this disclosure the phrase commodity will be used broadly to refer to tradeable items, including, but not limited to goods, services, and real property. While conventional pricing methods consider pricing information from the single market in which the commodity is marketed (intra-market information), the process and system herein can predict the price of the good or service by considering both intra-market information and information across multiple markets (inter-market information). Therefore, the process and system described herein amalgamate predictive pricing factors obtained from intra-market information and inter-market information into a single pricing model for each commodity in a database.

As used herein, an estimation of price may be an estimated prediction of a fair price or price range at a current time, or may be an estimated prediction of a fair price or price range at a future time or times. The timing for which the estimate is produced may in this document sometimes be referred to as the “epoch”. Thus, for example, by obtaining estimated values for current price as well as estimated values of prices for one or more future times, a user may be able to detect trends in prices and thereby be enabled to time his transactions at more optimal timings.

In one aspect, a price prediction model is built in response to a trigger. The trigger for building the model may include a request from a user for a price determination of a commodity. Other triggers, discussed below, are possible. Based on the model, and in response to the user request for price, an estimate is made of the price or a price range of the commodity requested by the user, and the estimate is returned to the user.

In another aspect, the system and method determine cross-correlations in a database which includes pricing information for a plurality of commodities and other more general economic information that might be applicable for pricing the plurality of commodities. The system and method determine prices for all or nearly all of such commodities, or a subset of significant ones of such commodities, all in response to the trigger. The purpose of calculating prices, even for commodities not requested, is to improve the ability to predict prices generally.

In one aspect, a system and/or method for determining the fair price of a commodity (such as an asset, good or service) comprises the establishment of a database of commodities and factors that might or might not be related directly to the commodities, and the determination of factors contributing to the independent price of each such commodity. Responsive to a user request for the price of a commodity, there is a simultaneous determination or near-simultaneous determination of such factors for all or nearly all of such commodities in the database, a determination of the contribution of each such factor to the requested price, and the outputting to the user of the determined price, in response to his request.

In some aspects, the determination comprises a computer-controlled hierarchical tree, preferably running in the background or in parallel with the receipt of multiple ones of user requests. The hierarchical tree defines a plurality of nodes. The system and/or method comprises hierarchical classification operative to turn each factor on, across each of the nodes to allow primary ones of candidate factors to advance to a next node. A smart variable selection algorithm is operative to determine the significance of each such candidate factor to the request price.

In further aspects, the system and/or method obtains current factors from the user, and is operative to determine the contributions of the current factors to the requested price. “Current factors” may include, for example, information individualized to the user, generalized user information, or feedback obtained from sources independent of the user, such as feedback describing purchases ultimately made by the user, particularly purchases made in reliance on the estimate of fair price provided to the user. In this regard, discrete choice models may be employed, using such feedback, and thus incorporating the additional information provided by knowledge of the choices rejected by a user along the path to the choice ultimately made by the user in his purchase. For example, the prices requested by a user, particularly of alternative items, are also important especially insofar as other choices not selected by the user.

Primary factors of the system, which are used with or without current factors from the user, may include those factors obtained from inter market information or those factors obtained from intra market information, or both. Relevant market information is extracted. The factors (particularly as regards factors obtained from inter market or intra market information) are amalgamated and composited in a module for selection of variables so as to determine significance of each candidate factor to a requested price.

In some aspects, the system and/or method processes all factors (including factors pertaining to inter market and intra market information) for all or nearly all of the commodities in the database, to build a model for prices. Building of a model for prices proceeds by the generalized steps of determining correlations between and among factors and commodities, identifying candidate factors, determining factors of significance (such as by factor elimination), selection of model type or types (such as linear or log-normal models), and estimation of coefficients and parameters for the model. These steps are described in greater detail below. Building of the model is typically in response to a trigger mechanism. In some aspects, not all or nearly all of the commodities are processed. Rather, a subset of all commodities is processed, such as a subset of commodities comprising commodities determined to have significant correlation or inter-dependencies such that the determination of a price for one commodity is statistically significant and therefore helpful in the determination of the price of another commodity in the subset. Other definitions of suitable subsets of commodities are possible. In addition, it is possible to determine the price only for the commodity requested by the user, without necessarily calculating the price for multiple commodities. In such a case, updating of related or unrelated data may occur as data is narrowed along the way as the price is finally identified. By updating related or unrelated data along the way, the overall updating of increments of data will ordinarily make the calculations more available for subsequent calculations for a requested price.

Based on the model, and in response to the user request for price, an estimate is made of the price or fair price range of the commodity requested by the user, and the estimate is returned to the user.

It should be understood that in many typical implementations, not all or even nearly all of the commodities in the database are processed, at least not directly. However, even in implementations where not all or nearly all of the commodities in the database are processed directly, information regarding all or nearly all commodities is nevertheless used directly or indirectly in one way or another. As an example, a somewhat sophisticated indicator like “generalized state of the economy” will be clearly useful in determining large-scale prices such as the price of a house. But because that indicator might also indirectly contain or correlate to more particularized information, such as a “retail sector indicator”, the large-scale indicator for “generalized state of the economy” might be helpful in determining smaller-scale prices such as price and/or sales volume of novelties at a local festival.

The trigger mechanism for building of the model may include the request from a user for a price determination. Other trigger mechanisms are possible. As one example, the trigger mechanism might be the expiration of a time interval, wherein the time interval is a time interval whose length carries an expectation that there might be non-negligible changes in the calculated factors. The time interval might be short or long depending on the nature of the commodity. For example, in the case of a commodity involving the price of an actively traded stock, the time interval might only be a few seconds. In the case of a commodity involving of a relatively stable commodity, such as the price of a widely-available electronic device, the time interval might be a week or even a month. In the case of a commodity such as a newly-introduced electronic device, the time interval might be a few hours of a few days.

The calculations are preferably carried out in parallel, on multiple processors each operating independently of each other, and each receiving a test module for testing by the processor. One or more processors might, in addition, serve as coordination nodes, for coordinating the distribution of test modules to parallel processing nodes, and for compositing and analyzing results returned from the processing nodes. In addition, the coordinating nodes might implement an iterative process whereby, upon receipt of intermediate processing results from parallel processing nodes, additional test modules are distributed in parallel to the processing nodes, whereby the process is iteratively repeated so as to obtain needed correlations and factors, and so as to obtain determinations of factors of significance.

Thus in one general aspect, the disclosure herein is generally directed to the notion of an overall system for determining fair pricing of any commodity (“commodities” might include any of assets, goods or services), and typically not merely a one-market commodity. The system determines cross-correlations in a database which includes prices of such commodities and inter and intra market information, and determines prices for all or nearly all of such commodities, or a subset of significant ones of such commodities, all in response to a trigger mechanism such as a user request for a price of one such commodity. The purpose of calculating prices even for commodities not requested is to improve the ability to predict prices generally.

In reference to the term “cross-correlations”, it should be recognized that in the most mathematically rigorous interpretation, a correlation is a numerical quantity determined by formula, such as the formula given below in the section describing correlation coefficients. The mathematical properties of that formula only describe the linear interaction between the underlying random variables. The process described herein uses correlations, and may further use other and more sophisticated metrics (e.g. graphical models) to model the interaction of prices between different commodities. Thus, in many implementations, interactions beyond simply linear interactions are modeled. It should further be recognized that the word “correlation” is often taken to refer to the coefficient of a parametric model. Use of the word “correlation” in this disclosure sometimes refers to somewhat broader notions; for example, under a maximum likelihood framework, the regression coefficient around a neighborhood of epsilon radius (for a small enough epsilon) does indeed behave like the correlation between the underlying factor X_i and the response variable Y. The meaning of the word “correlation” will be understood from the nature of its usage.

In this aspect, a system and/or method for determining cross-market correlation factors which contribute to a response to a user request for a price comprises a database of assets, goods and services. The system is operable responsive to the trigger mechanism (e.g., a user request) to identify inter and intra factors which contribute to a price determination for nearly all of said assets, goods and services (perhaps being operative to identify “simultaneously” the inter and intra factors). Responsive to the trigger mechanism, the contribution of each of said factors is evaluated in a manner to identify factors of significance to the asset, good or service for which a price is requested, and a price response is produced to the request in accordance with contributions of all said factors of significance.

In another aspect, in a system and/or method for pricing a commodity, wherein the commodity might include any of assets, goods or services, a request is received from a user for pricing of a commodity. Responsive to a trigger mechanism such as receipt of the user request, and with respect to a database containing data for prices of commodities together with data for inter-market information and intra-market information relative to such commodities, inter-market and intra-market correlations are extracted with respect to prices of all or nearly all of the commodities in the database, or a subset of significant ones of such commodities, including the commodity indentified in the user request. The correlations may include known correlations or expected correlations, and may further include previously unknown or undiscovered correlations. In further response to the trigger, correlations of significance are differentiated from correlations which are not significant (such as by factor elimination), and factors for the correlations of significance are calculated. A fair price is predicted for all or nearly all of the commodities in the database, or a subset of significant ones of such commodities, including the commodity identified in the user request, by using the calculated factors and the correlations of the significance. The predicted price for the commodity identified in the user request is provided to the user.

In further aspects, the system and method obtain “current factors” from information provided by the user and “primary factors” from information retrieved from third party sources to determine the contributions of the current factors and primary factors to the requested price. “Current factors” may include, for example, information individualized to the user, generalized user information, or feedback obtained from sources independent of the user, such as feedback describing purchases ultimately made by the user, and particularly purchases made in reliance on the estimate of fair price provided to the user by the system herein.

“Primary factors” may include those factors obtained from sources other than the user, such as online marketplaces that track historical pricing of goods and services. In one aspect, the primary factors and current factors are used together by a variable selection module for selecting candidate factors used in a pricing model for a commodity. The variable selection module determines the significance of each candidate factor to the requested price.

In some aspects the price determination system and method generate a computer-controlled hierarchical tree structure of factors, preferably running in the background or in parallel with the receipt of multiple ones of user requests. The hierarchical tree defines a plurality of factors arranged as nodes arranged across markets. The factors are arranged across multiple levels of generality, beginning from the most general factors at the upper levels of the hierarchy down to the most product-specific factors at the lower levels of the hierarchy. For example, the factors at the top of the hierarchy can be applicable across multiple markets, while the factors at the lowest level of the hierarchy are generally applicable only to the market in which the commodity to be priced exists. The factors that are relevant across multiple markets are termed “inter-market” factors, and the factors that are relevant for only for the commodity to be priced are termed “intra-market” factors. The system and method employ hierarchical classifiers that “turn on” or “turn off” each factor in the hierarchy based on whether the factor is deemed to be relevant to the price of the commodity whose price has been requested by the user. In this aspect where factors are arranged in a hierarchical structure, cross-market (inter-market) correlation factors are determined which contribute to a price of a commodity requested by a user.

In some aspects, each time a price for a commodity is requested factors and correlations are not necessarily calculated from scratch using all available data in the database. Rather, the system and method can update existing factors, based on newly-available information collected from sources including the user and third-parties. Updating the factors and correlations using newly-available information, rather than calculations using all available data in the database, can yield significantly reduced processing times as compared to calculations using all the available data in the database. Such reduced processing times are particularly evident in situations where the update employs an approximation for the data, such as modeling an intrinsically nonlinear relationship as being linear. Even in such circumstances, calculations can still be triggered, periodically, for example, for full recalculation based on all available data, so as to remove the effect of accumulation of errors due to the approximation.

In some aspects, a system and/or method for determining a fair price of a commodity comprises the establishment of a database of such commodities, the establishment of a database of market information including intra and inter-market information, and the search of such databases to identify previously unknown or undiscovered correlations between entries therein. An assessment is made of the significance of such undiscovered correlations to the determination of a price, and such contributions are factored into those factors which are significant and those factors which are less significant. The factors of significance, primarily, are used responsive to a user request for a price determination, so as to provide the user with an estimate of a fair price for the requested commodity.

Mathematical techniques for identifying previously unknown or undiscovered correlations and factors include techniques that are known, techniques that are known but not previously applied in the field of price determinations, and techniques that are previously unknown but are disclosed herewith. Such techniques may be based on Akaike Information Criteria (AIC) and Bayesian Information Criteria (BIC), and use of log-likelihood techniques and other statistical models such as chi-squared models for elimination of candidates of lower significance, and identification of candidates having higher significance. Such mathematical techniques may be employed to build a model which when supplied with suitable values for factors of significance, together with an identification of suitable correlations in the database, amalgamates and composites the model so as to calculate a fair price for a commodity.

The system and method to determine (perhaps simultaneously) the price of all or nearly all of the commodities (or some subset of significant ones of the commodities) lends itself to the systematic process for identifying undiscovered inter-market (i.e., cross-market) correlations, which may contribute to the fair price of the good or service whose price has been requested by the user. Some embodiments employ a set of mathematical tools to identify such correlations and the contributions they make to the determination of a fair price. Thus, some embodiments are based on the realization that a system operative to compute simultaneously the price of some or all of the commodities in a database, in response to a user request, provides an opportunity for the systematic identification of undiscovered cross correlations between markets. The use of now-available computer power and parallel processing techniques, by which such power can be utilized in a practicable time, permit the integration of undiscovered cross-correlations into a timely response to a user's price request. The system and method employ mathematical tools described herein to assess the contribution of each identified inter-market correlation.

The system and/or method employs known mathematical tools together with mathematical tools not previously known but disclosed herein, to assess the contribution of each correlation so identified. Such mathematical tools might include correlation coefficients, factor building, score rating, hierarchical classifiers, smart variable selection algorithms, formula and formulated for calculating price, dynamic adjustment, model building and identification of inter and intra market data. Computational efficiency and the value of Akaike Information Criteria (AIC) and Bayesian Information Criteria (BIC) may also be used.

Mathematical techniques for identifying previously unknown or undiscovered correlations and factors include techniques that are known, techniques that are known but not previously applied in the field of price determinations, and techniques that are previously unknown but are disclosed herewith. Such techniques may be based on Akaike Information Criteria (AIC) and Bayesian Information Criteria (BIC), and use of log-likelihood techniques and other statistical models such as chi-squared models for elimination of candidate factors of lower significance, and identification of candidate factors having higher significance. Such mathematical techniques may be used to build the pricing model.

In this aspect, the process of distilling the most useful subset of candidate factors is a highly parallelizable process that can be carried out on a multi-core computer or on a cluster of distributed servers. In this general notion, a system and/or method is provided by which non-significant and/or redundant factors are eliminated by packaging candidates of possibly acceptable models into plural executable jobs, each testable independently and in parallel with the other. The packages of executable jobs are then distributed for testing, and the best candidate encountered so far for an acceptable model is selected. The process is repeated with the best model, until all factors in the model exceed a predetermined threshold of significance.

The variable selection process is a highly parallelizable process that can be carried out on a multi-core computer or on a cluster of distributed servers. Non-significant and/or redundant factors from among a plurality of candidate factors (comprised of intra- and inter-market factors) are eliminated by building intermediate models with subsets of the candidate factors and testing each of the intermediate “candidate” models in parallel with each other. The intermediate model yielding the “best” results, as discussed below, is selected. The process is repeated with the best model, until all factors in the model exceed a predetermined threshold of significance to the pricing model for the commodity whose price has been requested.

Thus, this aspect is particularly concerned with the realization of how to package the candidate models into independently testable packages of executable jobs that can be executed in parallel. Without this ability to test the candidate models independently and in parallel, the process of building a model would likely take too long for practicable and near-real-time interaction with a user.

Moreover, in this aspect, there is not necessarily a need for a trigger mechanism which determines when the models are calculated. The models can, for example, be calculated in advance and used later. In addition, there is not necessarily a requirement for calculating models or prices for all (or nearly all) of the commodities in the database.

Thus, according to this aspect, for eliminating non-significant factors from a model which predicts a fair price range for a selected commodity, a system and/or method comprises calculating cross-correlations in a database which stores data for the prices of commodities including the selected commodity, together with data for inter-market information and intra-market information relative to such commodities, and initializing a full model for the price of the selected commodity. The full model includes multiple factors selected based on the calculated cross-correlations. M executable jobs for test models are packaged, M being an integer greater than one, wherein each test model comprises the full model with 1 to M factors of lowest significance eliminated. The M executable jobs, each containing a test model, are distributed to M processors for execution in parallel, and a test result is received from each of the M processors. The test result is indicative of the likelihood that the eliminated factor (or factors) contributes to the significance of the full model. A coordinating computational node, such as the node that packaged and distributed the executable jobs, sequences through the test results in sequence starting from m=1 through M, determining if the test result is less than the likelihood that non-eliminated factors contribute significantly to the model. The first of such test models that satisfies this condition is selected, and the full model is updated by eliminating the factors determined to be non-significant. Thereafter, there is an iterated repetition of the above steps of packaging, distributing, determining, selecting and updating the full model, until all factors return a test result exceeding a predetermined threshold.

In particular embodiments described herein, in packaging the test models, factors are eliminated based on those factors having lowest chi-squared factors, and the test result received from each of the M processors comprises an average log-likelihood contribution of the eliminated factors, which is compared against the minimum chi-squared values of the remaining factors.

In particular embodiments described herein, in generating the candidate models, factors are eliminated based on the chi-squared factors of each candidate factor. In one embodiment, candidate factors having the lowest chi-squared factors are eliminated in groups, i.e., two candidate factors having the lowest two chi-squared factors eliminated in one candidate model, and three candidate factors having the lowest three chi-squared factors eliminated in another candidate model. Each candidate model, and the test result received from each of the M processors comprises an average log-likelihood contribution of the eliminated candidate factors, which is compared against the minimum chi-squared values of the remaining factors.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a conceptual view illustrating aspects of database building, identification of correlations and discovery of unknown correlations, factor elimination and identification of factors of significance, model building, and fair price determinations.

FIG. 2 is a conceptual flowchart illustrating a process for fair price determination.

FIG. 3 is a diagrammatic overview of system architecture showing a main database, a model building module, and a price prediction module.

FIG. 4 is an architectural view showing details of the main database.

FIG. 5 is an architectural view showing details of the model building module.

FIG. 6 is an architectural view of the price prediction module.

FIG. 7 is a representative view of a fair pricing system relevant to one example embodiment.

FIG. 8 is a detailed block diagram depicting the internal architecture of the server computer shown in FIG. 7.

FIG. 9 is a view for explaining software architecture of a control module for a fair pricing system according to an example embodiment.

FIG. 10 is a flow diagram for explaining control of a fair pricing system according to an example embodiment.

FIG. 11 is a flow diagram for explaining a record checking method according to an example embodiment.

FIG. 12 is a flow diagram for explaining a record updating method according to an example embodiment.

FIG. 13 is a flow diagram explaining a variable selection process employed in fair pricing system according to an example embodiment.

### DETAILED DESCRIPTION

Representative embodiments are described below. In the description of these embodiments, the following topics are discussed, and terminology is used as follows, unless the context suggests otherwise:
Correlation coefficients
Factor building
Hierarchical classifier
Variable selection
Formula(s) for calculating price
Dynamic adjustment
Model-building routines
Intra-market and inter-market information and data

These terms and these terminologies are explained more fully below.

1. Correlation coefficients: Let X and Y be two random variables defined on the same probability space (Omega, F, P), and further assume that both X and Y are square integrable with respect to P (by the Cauchy-Schwarz inequality, a well-known mathematical certainty developed between in 1821-1888, this assumption implies that the product XY is also integrable). The correlation coefficient between these two random variables is defined as: (E(XY)−E(X)E(Y))/(stdev(X)stdev(Y)). Here, E(.) and stdev(.) are the expectation and the standard deviation of the underlying random variable, respectively. The assumption that the random variables are square integrable, along with the Cauchy-Schwarz inequality, together guarantee the integrity of the above calculation.

If the correlation between X and Y is positive, this indicates X and Y are statistically more likely to move in the same direction; if the correlation is 0 (or statistically insignificant from 0), the movements of X and Y are statistically more likely to be linearly independent of each other; if the correlation is negative, the movements of X and Y are statistically more likely to oppose each other. The absolute value of the correlation coefficient, which only ranges between −1 and 1, indicates the strength of their relationship.

2. Factor building: Factor building and score rating are a part of the general regression framework, where a response variable Y is modeled by a number of predictors X1, X2, . . . , Xn. Non-limiting examples of regression models include models that are polynomial (including linear), geometric, exponential, log-linear, log-log, and the like, and combinations thereof. In the above set up, a predictor Xi is called a “built factor” if Xi can be directly computed from the input data. On the other hand, if Xi is the output of another layer of sub-model, then it is called a “score rating”.

For example, as a measure of the general state of the economy, one could just use the Dow Jones Industrial, and then this particular Xi will be a factor. On the other hand, if a complicated sub model is built, which gives the current state a rating of 7/10, then this will be a score rating for this request.

3. Hierarchical classifier: In the system of regression models that employed herein, the hierarchical classifier is a system which grades the information content to be used at each level. The output value of the hierarchal classifier is often just a 0/1 variable that determines if the corresponding factor should filter through the next layer of the network. The value of the classifier can be determined by data, model, and sometimes by human common sense.

For example, the types of data classifiers could be whether a product is in a certain industry: yes/no. In this example, it is expected that factors and ratings designed specifically for one industry (e.g., the food industry), will have very little to do with pricing of commodities in another industry (e.g., antiquities). An example of a model classifier could be a rating for the current state of the economy. It is well known that determinants of security prices are very different during different stages of the business cycle.

One point of such a classifier is that at the top of the hierarchal structure, there are factors and ratings that are so pervasive that they matter to every product at every geographical location during every phase of the business cycle. One example is the price on offer for that product; its regression coefficient is called the price elasticity in the economic literature. On the other hand, there are other data which only comes to play for a subset of the scenarios, and a methodology is provided on how information should be filtered from the very general to the very specific.

4. Variable selection: One issue with regard to the variable selection problem is that, in a model where Y is designated as a determinate and X1, X2, . . . , Xn are designated as predictors, some of the Xi's might or might not be statistically significant enough to go in the final model. It is also well known in the statistical literature that a model with too many redundant factors will not make correct out-of-sample predictions. An algorithm to select variables (or, stated another way, an algorithm for elimination of factors) is a way of choosing or approximating the best subset of the candidate factors to go in the final model, such that accuracy of out-of-sample predictions can be guaranteed within a certain error range, at a certain predetermined probability. These quantities are called the “prediction interval” and the “significance level” respectively.

To achieve the above outcome, there are three standard strategies that are widely available in the literature and in statistical software: forward selection, backward selection and stepwise selection. Any strategy that is either faster and or “better” than the three standard strategies can be called a “smart strategy”. To measure the run-time of each strategy is relatively simple, but to measure the “goodness” of the final model is generally more difficult. The most desired measurement is probably out-of-sample performance (i.e. accuracy in predicting the future), but this cannot be done until the future, when the future is actually known. Other methods such as jack knifing, bootstrapping and cross validation are all based on the idea that the future can be “simulated” from within the data sample (e.g. cover up a data point, run the model, and re-predict as if it was the future). There are penalty based measures such as Akaike and Bayesian Information Criterion (AIC and BIC), which also measures the “goodness” of a model. These and other issues illustrate the fact that measuring the “goodness” of a model can be complicated.

The smart variable selection algorithm proposed herein does not necessarily aim to produce a substantially better model than if one of the three standard algorithms were selected (but it won't produce a worse model either), it is the parallelization construct that allows it run potentially hundreds or thousands times faster than the standard algorithms on a sufficiently powerful super computer or grid of computers. Without the benefits provided by the algorithm proposed herein, it might take years or even decades to run a model on as a grand scale as that described herein. Perhaps this explains why to date, there are a myriad of software on property pricing, motor vehicle pricing, jewelry pricing etc, but there is nothing that look at them simultaneously, and therefore all cross related information are lost in translation.

5. Formula(s) for calculating price: The formula for calculating the price could be different for each product, because the model structure at the very bottom of each hierarchal structure could be different. The exact nature of the formula/formulae should not be limited by the examples provided herein. Non-limiting examples, for the purposes of illustration and demonstration, are provided as follows:

a. If the price of the final product follows a normal distribution, then the pricing formula is just: Y (price)=constant+beta1*X1+beta2*X2+ . . . +betan*Xn. Here, X1, . . . , Xn are the final factors (i.e. after smart variable selection) in the last hierarchal level relating to that product; constant, beta1, . . . , betan are regression coefficients determined by the method of least squares (least squares only works because Y is normally distributed).

b. If the price of the final product follows a log normal distribution, then the pricing formula is just: Y (price)=exp(constant+beta1*X1+beta2*X2+ . . . +betan*Xn). Here, X1, . . . , Xn are the final factors (i.e. after smart variable selection) in the last hierarchal level relating to that product; constant, beta1, . . . , betan are regression coefficients determined by the method of least squares after taking a log-transform (least squares only works because log(Y) is normally distributed).

c. If the price of the final product follows an exponential dispersion family, and a generalized linear model (GLM) with link function eta is being used (all GLM's have a corresponding link function), then the pricing formula is just: Y (price)=eta(constant+beta1*X1+beta2*X2+ . . . +betan*Xn). Here, X1, . . . , Xn are the final factors (i.e. after smart variable selection) in the last hierarchal level relating to that product; constant, beta1, . . . , betan are regression coefficients determined by maximum likelihood.

d. If the price of the final product follows a mixed linear family with link function eta, then the pricing formula is going to be: Y(price)=int_B eta(constant+beta1*X1+beta2*X2+ . . . +betan*Xn) dF(beta). Here, int_B . . . dF(beta) means to integrate everything in between with respect to the probability distribution F(beta) over the domain B, and where B represents all possible values where the vector (beta1, . . . , betan) can be defined on.

One point to be understood from the above examples is that the pricing formula can be very different depending on the actual asset/product/goods or service that is being predicted, and it would be almost impossible to provide an exhaustive list of formulas in advance without severely and unnecessarily limiting the scope of applications for the inventions described herein.

6. Dynamic adjustment: Dynamic adjustment is a process which updates the most recent data from the buffer to the model builder, re-runs the model, and generates the latest coefficients. Dynamic adjustment can be performed pursuant to a timetable, such as a repetition on an annual basis.

7. Model-building routines: The basic architect of the model is that there is a hierarchal tree running in the background, and from that is built whatever factors/ratings at each hierarchal level (depending on the local parameters). The hierarchal classifier will turn each factor on/off at each node. At the product level, it will scan for all the factors/ratings which are left on at each parent node, and they are called the candidate factors. The candidate factors will be thrown in the smart variable selection algorithm, which eliminates the insignificant factors and distills out a subset of the candidate factors that are significant and that are included in the final model. Depending on the actual product, the final model will have a different functional form, and hence may yield a different pricing formula.

8. Intra-market and inter-market information and data: Intra-market data refers to data that are specific only to the final product. For example, in the pricing for second hand cars, factors such as year, make, engine, etc are applicable primarily only to second hand cars, and they are meaningless in many other markets. These information are called intra-market data. Inter-market data may include things like state of the economy, average income, location, etc, and they can be used to determine second hard car prices, as well as a variety of other things.

### A First Example Embodiment

In a first example embodiment described herein, systems and methods are described in the context of a distributed computing environment. It should be understood that such an environment is not limiting, and that in other embodiments all or some of the systems and methods may be implemented in a dedicated environment. In addition, it should be understood that the systems and methods described in the context of this embodiment may be combined with those of other embodiments.

It should be recognized that in this first example embodiment, a price estimate is provided at a specific timing or epoch for the estimate, i.e., a current (present) time versus a future time or times. Specific trigger events are described, such as a user request for a price estimate, a change or update to underlying data for inter-market and intra-market information, or elapse of a period of time (such as daily or weekly or monthly). Further, specific actions taken in response to the trigger events are described, such as identification of factors of significance, elimination of factors deemed insignificant, estimation of parameters signifying relative importance of the factors, building of the model, and implementation of the model to provide a price estimate. It should therefore be understood that the nature of the epoch for the estimate, the nature of the trigger event or events, and the nature of the calculations and responses undertaken in response to the trigger event are not limiting, and each may be combined with others in this or in other embodiments.

To reiterate on some background described above, information asymmetry is pervasive in many real life markets, ranging from real estate, antiquities and collectables to hotels, plane tickets, coffees and sandwiches. This will inevitably put the consumer at a weaker bargaining position, and hence lowering the overall market efficiency. This disclosure provides a tool for the common consumer, who lacks the time and resource to conduct as a thorough research, an independent and objective opinion on the price of the underlying.

While this endeavor is not completely new on a one-market scale, to the inventors's knowledge, nothing of this kind exists on a cross-market scale. One of the biggest advantages of the process described herein is that it is not just a simple amalgamation of prediction models for each individual markets; rather, the interaction terms between the underlying markets play a fundamental role in the prediction process.

For example, consider the pricing services offered by RP Data Pty Ltd, which is an Australian company said to electronically value every single property in Australia on a weekly basis. Although services such as RP Data will estimate a “fair price” for real estate in Australia, such services do not provide any analysis on retail items, nor will such services use retail item prices as a leverage to compute a more accurate real estate price. In contrast, in one example of the method and system described herein, in the more affluent suburbs, it is likely that there will be see more expensive shops, cafés and restaurants, and the presence of this information in the database will inevitably lead to more accurate pricing of real estate in the surrounding neighborhood.

Another example could be the correlation between “average” airline prices and hotel prices of the destination city. Namely, if the average airline price at a certain date, to New York say, is statistically higher than average, this is an indicator that more than average number of people are travelling to New York on that day. Hence, if on average New York hotel prices remain the same, then it can be surmised that the rooms are underpriced.

The above examples demonstrate two instances where the efficiency of the process described herein will clearly out-perform any existing pricing platforms that operate at one-market scale.

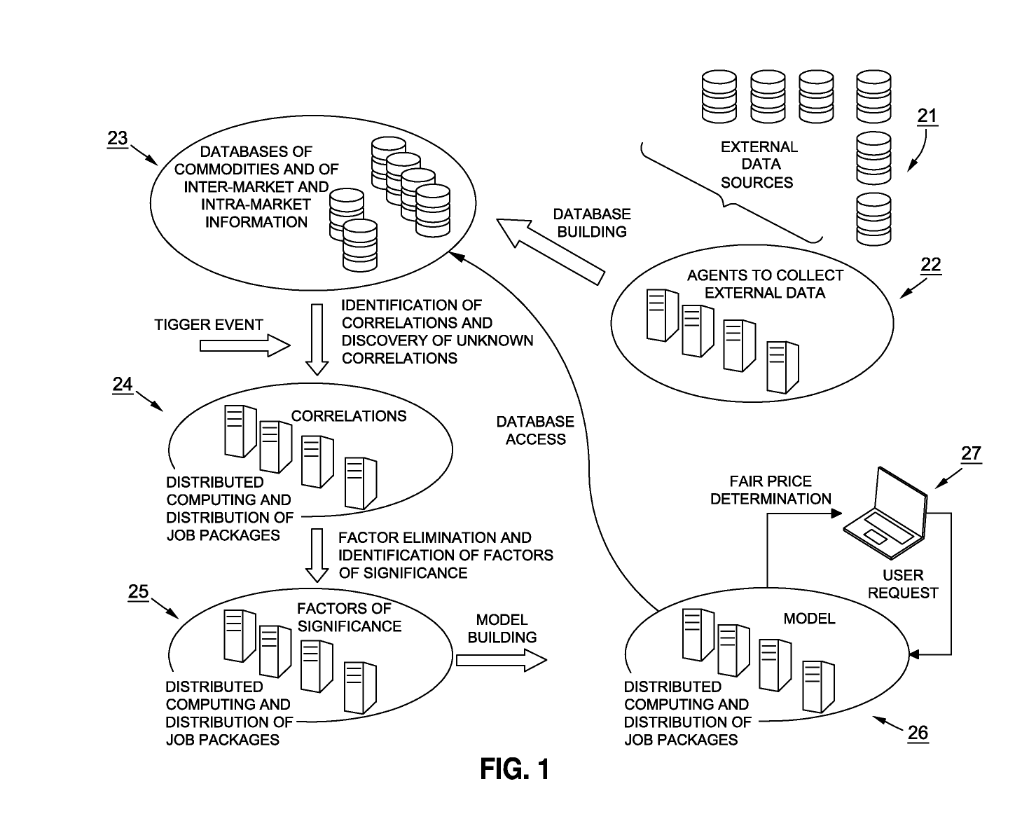

FIG. 1 is a conceptual view illustrating aspects of database building, identification of correlations and discovery of unknown correlations, factor elimination and identification of factors of significance, model building, and fair price determinations. As seen in FIG. 1, external sources of data 21 are scraped for pertinent data by agents 22 which call the external sources of data and extract pertinent data. The data extracted by agents 22 are built into databases 23 of commodities and of inter-market and intra-market information. It will be appreciated that in the context of the FIG. 1 illustration, the external sources of data 21 are distributed sources which are distributed over the Internet or intranet, the agents 22 are agents that are likewise distributed, and the databases 23 are distributed, perhaps at remote locations.

At 24, there is identification of correlations and discovery of unknown correlations from the databases 23 of commodities and of inter-market and intra-market information. The correlations may be identified, and the unknown correlations discovered, based on a trigger event or events. In general, because of the computational burden in identification of correlations, and in discovery of unknown correlations, correlations 24 may be obtained via distributed computing and distribution of job packages through grid computing.

At 25, factors of significance are identified, and factors deems insignificant are eliminated. Again, the factors of significance may be obtained via distributed computing and distribution of job packages in grid computing, owing to the computational burden involved.

At 26, a model is built using the factors of significance. The model typically will have access to the databases 23 of the commodities and of inter-market and intra-market information.

At 27, in response to a user request for a price estimate, the model is implemented, and the database is accessed, so as to return a fair price determination to the user.

FIG. 1 thus illustrates some of the aspects described herein. In this diagram, external databases of information are examined by computerized agents which collect meaningful information and build a database. The agents crawl the Internet automatically collecting data from a pre-designated collection of databases of interest. Crawling of the Internet is mostly continuous, for the reason that most databases are not static. Classified advertisements in newspapers, for example, change constantly, as do pricings reflected by databases such as Amazon™ and eBay™. In addition, over time, some databases and data sources become less significant and others (perhaps not yet identified for inclusion in the pre-designated collection of databases) become more significant. According, the pre-designated collection of databases is updated over time, perhaps by the computerized agents themselves, and preferably at timings with regard to the integrity and value of the data that contributes to the collections from which calculations are made. Newly-identified databases are included in the pre-designated collection for crawling in future cycles by the agents.

The database comprises commodities and price histories for such commodities, together with inter-market information and intra-market information potentially meaningful to the pricing of the commodities. An identification is made of correlations in the database and discovery of previously-unknown correlations amongst entries in the database, perhaps in response to a trigger event, and preferably in parallel using distributed computing. Factors of significance are identified, and non-useful redundant factors are eliminated, again preferably in parallel using distributed computing. A model is built using significant factors. In response to a user request for an estimate of fair price, the model is executed against the data in the database, so as to provide the user with a determination of fair price. Not shown in the diagram is the feedback based on the way that the user uses the estimate of price. For example, the user might request prices for multiple items considered alternatives to each other, and might request prices over a period of time. The choices rejected by the user in leading to his ultimate purchase can be incorporated into the model, such as by incorporation of a discrete choice model.

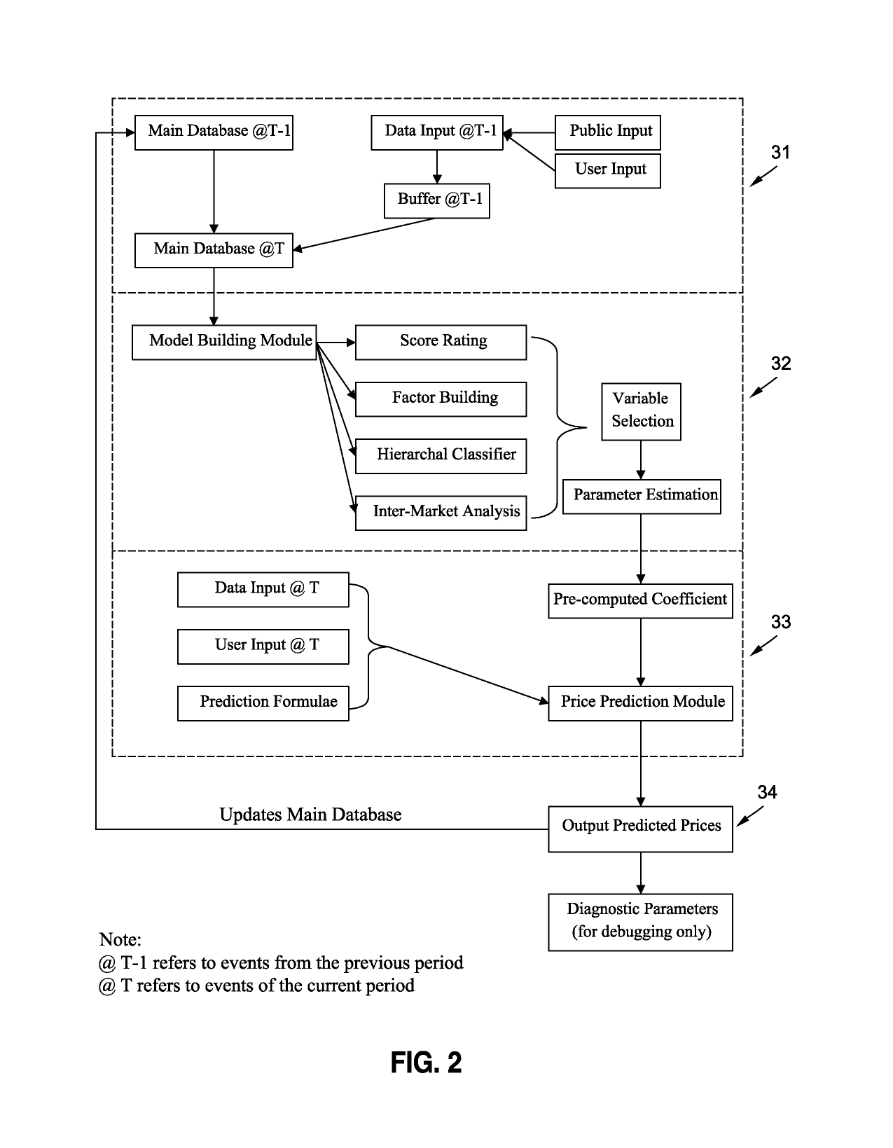

FIG. 2 is a conceptual flowchart illustrating a process for fair price determination. The flowchart includes the notion of a time progression from a time T−1 to a subsequent time T.

In FIG. 2, at 31 a main database at time T−1 is updated to a main database at time T. Update of the main database is effected through data inputted at time T−1 and buffered at time T−1. The inputted data may be public data or user data, and may, for example, be gathered by agents 22.

At 32, a model building module operates to build a model for fair pricing. The model building module may employ, for example, score rating, factor building, hierarchical classification, and inter-market analysis. Based on such considerations, variables and factors of significance are selected, and factors not deemed significant are eliminated. In addition, parameters are estimated for such factors. In general, the parameters are in some sense a weight indicating the relative importance of the factors and variables that were selected.

At 33, based on data input at time T, and user input at time T, the model is implemented so as to predict a price for the requested commodity. The predicted price is output at 34. In addition, the predicted price estimate is provided back to the main database, in a feedback relationship, so as to provide an update to the main database which thereafter uses the predicted price output at 34 in a next iteration for time T+1. Such feedback may result in a trigger event.

It will be appreciated that in FIG. 2, diagnostic parameters may also be output, for debugging purposes.

### System Architecture:

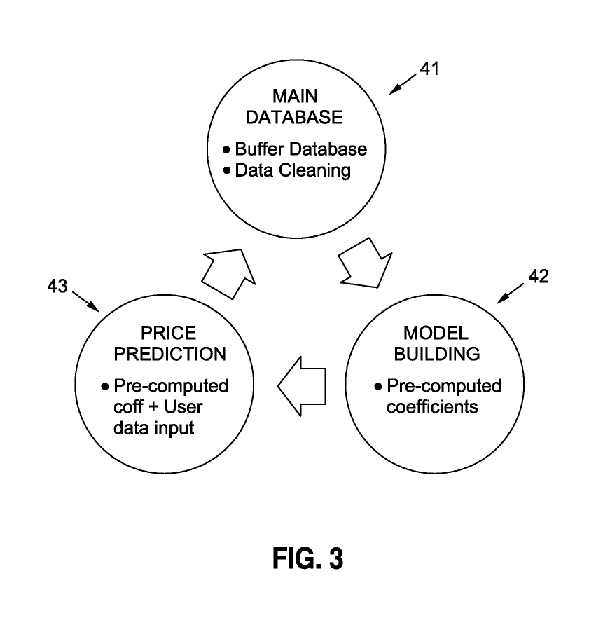

FIG. 3 is a diagrammatic overview of system architecture. As shown in FIG. 3, the system architecture includes three (3) primary constituents: a main database 41, a model building module 42, and a price prediction module 43. Main database 41 includes a buffer for the database, together with data cleaning modules so as to ensure integrity of the main database. The model building module 42 functions as described above to identify factors of significance and to eliminate factors that are deemed insignificant, and in addition estimates parameters signifying the relative importance of such factors. The price prediction module 43 uses the pre-computed coefficients from the model building module 42, together with user input, so as to provide a prediction of a fair price for the commodity. The outputted price prediction from price prediction module 43 is provided back to main database 41, for use in update of the main database.

1. The prediction model is built from data in the main database. The pre-computed coefficient for each market in the main database is stored in a temporary folder for fast access.

2. From the pre-computed coefficient and the relevant user data input (for the given asset, goods or service), the process makes a prediction of the fair price.

3. The system updates the user input information and the “current prediction” to a buffer database.

4. The buffer database is cleaned and then combined with the main database once every so often (e.g. weekly, monthly or annually, depending on the timing sensitivity of the underlying).

### Database Routine

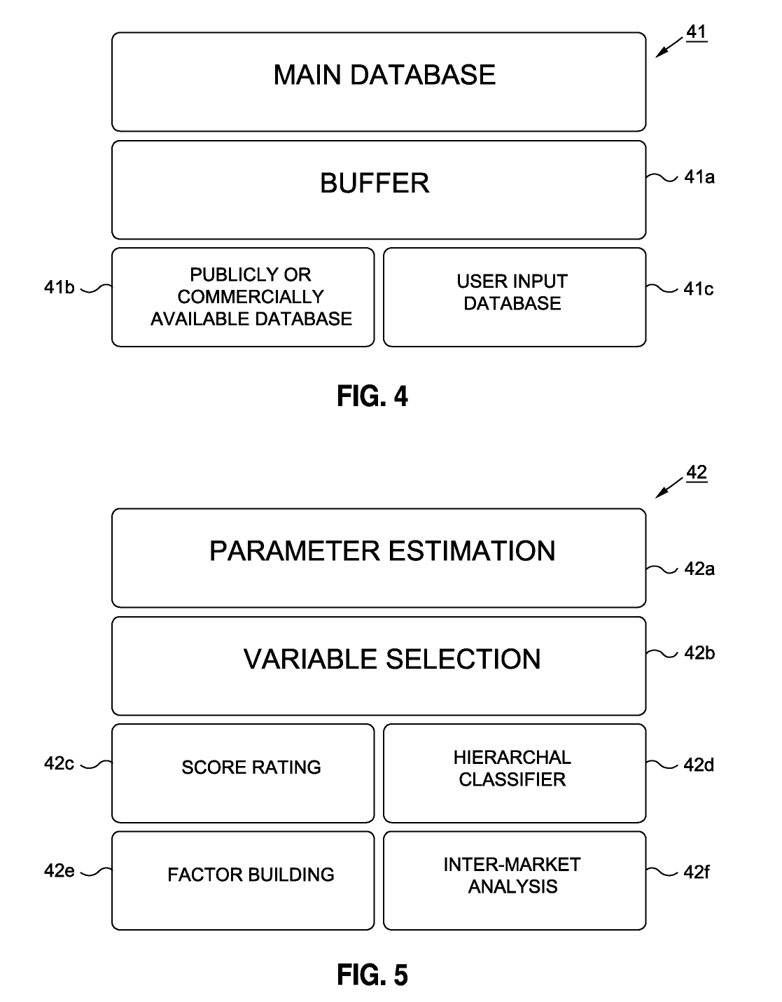

FIG. 4 is an architectural view showing details of the main database. As shown in FIG. 4, main database 41 includes a buffer 41a for buffering of data such as publicly or commercially available data at 41b, or from data input via a user from a database at 41c.

1. The main database takes two sources of information input.
a) Publically available sources
b) User input sources (user input need not imply manual input)

2. The information collected in 1) is temporarily saved in a buffer.

3. The data in the buffer will be filtered and cleaned for invalid entries or entries that require special treatment (e.g. missing value).

4. Depending on market sensitivity of the underlying (for each underlying, this is determined algorithmically by a component in the model building routine),

### Model Building Routine

FIG. 5 is an architectural view showing details of model building module 42. As shown in FIG. 5, model building module 42 includes parameter estimation modules at 42a and variable selection modules at 42b. To select variables and other factors of significance, and to eliminate factors that are not deemed significant, variable module 42b may utilize score rating at 42c, hierarchical classification at 42d, factor building at 42e, and inter-market analysis at 42f.

1. The inputs of the Model Building Routine are from the current state of the main database of the previous routine. Hence, the output from executing this routine is dynamic with respect to the state of the previous routine.

2. There are two unrelated sub-modules to this routine. The purpose of the score rating and factor building modules are to extract intra-market information; and the inter-market analysis and hierarchal classifier routine are to extract inter-market information.

3. The intra and inter-market information are amalgamated in the variable selection module. This module's purpose is to distill the most useful information from the amalgamation. This is accomplished through the application of a library of statistical tools. These include stepwise selection, backward elimination, and also newer and more sophisticated algorithms disclosed herein.

4. The output of 3) gives a distilled set of most useful predictors of the price of the underlying. The model in this step is finalized by estimating the parameters.

5. There will be two types of output from the model building routine.
a) The first is the pre-computed coefficients, which will be invoked by the Price Prediction routine.
b) The second is a collection of system diagnostic parameters. An example of this is the measure of market sensitivity mentioned in the previous routine.

### Price Prediction Routine

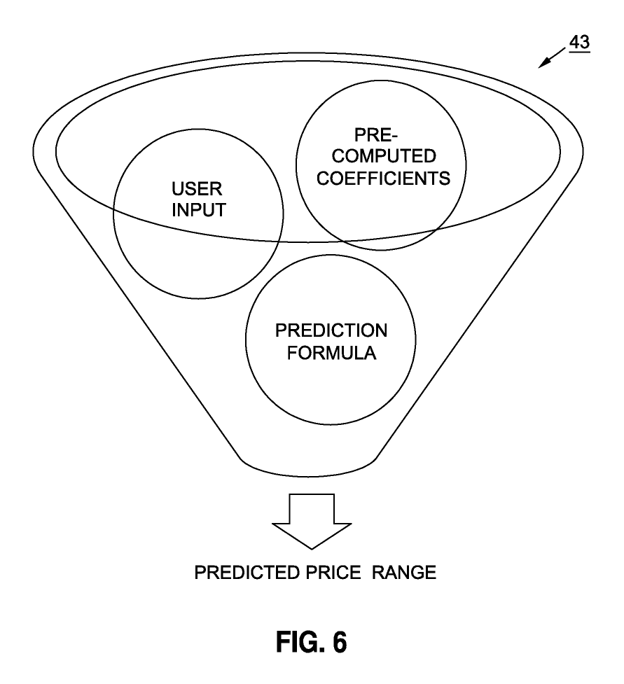

FIG. 6 is an architectural view of price prediction module 43. As shown in FIG. 6, based on user input and on pre-computed coefficients from model building module 42, together with a prediction formula from model building module 42, a predicted price range is produced for the user. As previously indicated, the predicted price range is provided back to the main database 41, where it is used as additional input in subsequent iterations of price prediction.

1. The user will be asked to input
a) Item specific information
b) Market specific information

2. The process will combine
a) The input from 1)
b) Pre-computed coefficients from the Model Building Routine
c) The relevant price prediction formula (which could be market dependant)

And give the user the predicted price range.

### Detailed Description of Processes and Algorithms

The algorithmic approach of the process will now be described. For purposes of explanation, each step of the process is accompanied by a demonstration of how the process can be applied to estimate the price of a real estate property.

The process also uses a number of well known mathematical routines. These include but not limited to,
1. Maximum likelihood estimation
2. Bayesian inference
3. EM algorithm
4. Support vector machines
5. Artificial neural network
6. Curve fitting and splines

No per se claim is made to any one of the above methods or algorithms, divorced from the application to pricing as described herein. Instead, one feature of the system and method described herein is a process that uses the above tools to perform a function that is not seen—namely, to calculate the fair price of any asset, goods and service in a database of such commodities on a global scale. As an analogy, virtually no patent applicants will claim they have invented the computer, but many of them would use the computer as a tool for a new function.

The steps in the process are roughly organized as follows:
I. Database: Collect, Clean and Automate
II. Model Building
III. Price Prediction

### I. Database: Collect, Clean and Automate

For each asset, goods or services operated on, the process will begin with an initial database of publically or commercially available information. Examples of possible data providers could be Google, Amazon, Ebay, etc. The data providers which are particularly useful will provide the following services:
a. Historical database of traded prices
b. Automated updating routine over the internet (e.g. through an API).

The process may ask for user's authorization before it saves user input data in a buffer folder. The user may choose not to give the process consent to save his or her input information, and that will have absolute no effect with the service he or she shall receive from the process whatsoever.

Where user's consent is given, his or her input data is temporarily saved in a buffer folder on the computer's hard disk. Any update files from third party data providers will also be saved in a different buffer folder, often on the same computer.

With reasonably high probability, the user who made the data input will become an eventual buyer or seller; and when he or she becomes an eventual buyer or seller, his or her action of purchase or sale, with reasonably high probability, will be registered with a third party data provider. This permits a cross-check of the validity of the data.

For example, say Amanda is looking to buy a book on Amazon. She might enter the relevant details about that book, before making the purchase on Amazon. When eventually she does make the purchase on Amazon, the process's Amazon data feed will show this purchase, which enables cross-checking

If the cross-check result matches, this gives important confirmation about the correctness of third party data providers, as well as the competence of the end user. Otherwise, this indicates either
a) Third party provider's data source could be unreliable for the present intents and purposes. In that case, the data collected will provide a flag for correction by the third party data provider. Or,
b) The “average” end user may have been confused with the information they are asked to input. In that case, feedback on this point will improve the system's user interface.

Either way, collecting user input will help the process to improve the quality of the service in the long run.

Before the content of the buffer folder is updated to the main database, the following conditions must ordinarily be met:
1. The duration between now and the last update is greater than or equal to the recommended duration computed by the model.
2. The pre-update content meets the requirement of the data filter.

The data filter is a logical algorithm which detects for
1. Missing values and error data types. (e.g. “.” for traded price)
2. Values beyond reasonable means. (e.g. $10,000 for a cup of coffee)

Since the data quality of each market is different to one another, the treatment for missing or error values will be different for each market. This difference is algorithmically computable as follows.

A complete record is a record on a data table, where every field of that record is neither missing nor unreasonable. A complete field is a field on a data table, where every record of that field is neither missing nor unreasonable.

The process will treat a record in a particular field missing, if that record:
1. Holds the value that is reserved for “Null” in that field.
2. Data type is different to what was declared (e.g. when amount paid should be a numeric, but a character string is observed—e.g. a word, entry instead).

The process will treat a record in a particular field unreasonable, if that record:
1. Exceeds 5 standard deviations away from the mean of that field.
2. Those that exceed 5 standard deviations make up less than 1% of the records in that field.

Then, for each market, calculate the number of average percentage of complete records.

If the answer to 1)
a) Exceeds 70%, and
b) The absolute number of complete records exceeds 1000

Then, delete all records with at least one missing field, and update the remainder to the main database.

If the answer to 1)
c) Does not exceed 70%, or
d) The absolute number of complete records does not exceed 1000

Then, delete the field with the greatest number of missing or unreasonable record, and re-try a)-d).

### II. Model Building

The objective of this routine is to produce:
a. The pre-computed coefficients, and
b. A set of model diagnostic parameters,

using information available in the main database described by section I, “Database: Collect, Clean and Automate”.

There are three major steps in the model building routine before the final output is obtained:
1. Summary of intra-market (item specific) information: Score rating and factor building.
2. Summary of inter-market (market specific) information: Inter-market analysis and hierarchal classifier.
3. Distilling of the amalgamated information: Variable selection.

A factor is a number that is either directly measurable, or a simple arithmetic of directly measurable quantities. For example, average house sales price in the last six month, would quantify as a factor.

A score rating is itself a mini-model, which is algorithmically determined by much more subtle quantities that are, ultimately, directly measurable. For example, the competitiveness of the economy: rating, 0-10. In the process described herein, this figure will most likely come from a regression model, with factors such as Dow Jones Industrial Average, level of unemployment, percentage of growth and risk rating. Each one of the factors will ultimately be directly measurable: the first three are obviously directly measurable, while the last will be another mini-model, with its own factors. Eventually, the mini-model in the last layer will comprise of quantities that are directly measurable.

The mini-model's model coefficient will most likely be determined by one of the following ways:
a) Maximum likelihood (this includes the method of least squares)
b) Bayesian estimation
c) Curve and surface fitting methods, such as splines.

All three methods are completely deterministic and algorithmic, with the possible exception of Bayesian estimation if Monte Carlo Markov Chain is required. However even in this instance, the process retains its automatic and algorithmic nature. The result is random but the margin of error can be easy controlled by simply adding extra Monte Carlo trials. All three methods above are well established in the statistical literature. Their performance and reliability have been repeated tested in a myriad of applications.

Inter-market analysis and hierarchal classifier aims to achieve the following result: For each item in the database, it classifies them in a hierarchal tree structure. At the top of the structure are general quantities that affect all subsequent levels below it. At the bottom of the structure are very specific quantities that may only affect the underlying item only. Multiple hierarchal structures may overlay one another.

For example, with real estate, quantities such as state of the economy, will sit on top of the hierarchal structure. While moving down each level, the quantities get more specific. At the next level down, there might be two hierarchal structures overlaying one another, such as:
1. Type of property: Apartment, Townhouse, House, or Rural.
2. City/Suburb.

A quantity which measures the state of the economy of a given city or suburb will not only impact the house price, it will also help to predict the premium added for retail products sold in that city or suburb. Conversely, the score rating measuring the state of the economy of a given city or suburb could be a mini-model which uses past sales data of house price and/or price of retail items in that city or suburb.

One risk of modeling with market interaction terms is what is sometimes called “spurious correlation”. This is when numerical correlation arises in data without regarding the underlying causality in the context, giving rise to completely nonsensical conclusions. An example of this in Wikipedia states, “(Ice cream) sales highest when the rate of drowning in the city swimming pool is highest”. The hierarchal structure is precisely designed to mitigate this risk. Even if a spurious factor did step into the mini-model, with very high probability, it will make a very small contribution to the overall prediction, as other factors in the mini-model would dilute it out.

In some embodiments, the hierarchal classifier is not completely algorithmic. Machine learning algorithms such as support vector machines, link analysis and cluster analysis will be used in certain circumstances, but to date there is not always a known algorithm in existence that is capable of making human common-sense completely redundant.

For example, referring to a real-estate example in Australia, a thorough search using cluster analysis or support vector machines may help to identify Point Piper to be a much more affluent suburb than Penrith. Link analysis may help to rank each measurement or rating from most common to most specific, and thereby establishing a hierarchal structure from that. More subtle information, such as an identification of those parts of a particular street that might be particularly unpleasant to live in, will be very difficult to discover purely by algorithm. A human being on the other hand, only needs to drive by to find that it is particular uncomforting. In a counterpart example of real-estate in the United States, a thorough search using cluster analysis or support vector machines may help to identify Georgetown to be a much more affluent area than other parts of Washington, D.C. Link analysis may help to rank each measurement or rating from most common to most specific, and thereby establishing a hierarchal structure from that. More subtle information, such as an identification of those parts of a particular street that might be particularly pleasant to live in, despite being in a less-affluent neighborhood, will be very difficult to discover purely by algorithm. A human being on the other hand, only needs to drive by to find that it is welcomingly pleasant.

Theoretically, with a large enough database of user feedback, the process can significantly increase the automated proportion of the hierarchal structure. However, at this time, the inventors believe that active human intervention can be helpful and should not be completely eliminated—although the degree of human intervention does not go beyond simple application of common sense.

The information gathered for intra-market and inter-market of each underlying factor manifests as an amalgamation of candidate factors for the main model. Typically, the number of candidate factors in the main model would be in the thousands. The final step is a process that distills the most useful subset of the candidate factors before the model is built.

This endeavor can be achieved by invoking the following process. The process is regarded as superior to more common variable selection processes available in university text books, such as forward selection, backward selection and stepwise selection. Here, superiority is measured by,
1. Computational efficiency
2. Value of the Akaike and Bayesian information criterion of the selected model.

The goodness of fit for statistical models is commonly measured by the value of log-likelihood of the model. However, since the log-likelihood value always improves for models with more factors (regardless of whether they are useful or not), Akaike information criterion (referred to as “AIC” from here on) and Bayesian information criterion (referred as “BIC” from here on) are two well established ways of penalizing models with extra number of factors. Namely, they would each set a different tradeoff criterion whereby if the new factor does not improve log-likelihood by a certain threshold, the new model would be regarded as inferior.

Since the log-likelihood is at the maximum when all candidate factors are in the model, the process described herein will first fit the data to this model; the resulting log-likelihood value is referred to as L_max. Standard backward elimination would eliminate the candidate factor with the highest p-value and re-fit the model, and then repeat the process until the p-value of all factors are less than a pre-determined number, alpha. The drawback with this is that the process can be very slow, and the procedure is very difficult to implement parallel computation on a multi-core CPU.

The process described herein differs from backward elimination in at least two ways:
1. More than one candidate factor may be eliminated at a time.
2. The process is highly parallelizable on a multi-core computer, or on a cluster of distributed servers.

The chisq (“chi-squared”) statistic of a factor is its coefficient predictor divided by the standard error of that predictor. A well-known fact in statistics is that each time one factor is eliminated, the change in log-likelihood value is equal to half of the factor's chisq statistic. Therefore, each time when the process herein eliminates a block of candidate factors, the chisq value of the new model is compared against that of the old model, to measure the total information contribution of that block of candidate factors. If the average contribution of the eliminated block is less than the minimum chisq value of the remaining candidates, and the total change log-likelihood is less than a pre-determined threshold, then the block of candidate factors is eliminated.

The next issue is the efficient computation of which block to eliminate. The process described herein for elimination of blocks is highly parallelizable, and hence computation time will be very short compared to backward elimination (which is very difficult to parallelize) and can utilize powerful multi-core computers (or clusters of computers).

Let m be the total number of candidate factors and n be the total number of CPU's available for computation. For example, a good laptop nowadays could have 8 cores, so m=8; while a cluster of supercomputers can have hundreds or thousands cores.

Step 1: Run the full model, and order candidate factors by their chisq statistic from highest to lowest.

Step 2: Distribute the following models simultaneously to m cores:
(i) Full model with lowest chisq factor eliminated.
(ii) Full model with lowest two chisq factors eliminated.
(iii) . . . .
(m) Full model with lowest m chisq factors eliminated.

Step 3: Starting with the model with lowest m chisq factors eliminated, check if the following condition is satisfied: whether the average log-likelihood contribution of the eliminated block is less than the minimum chisq value of the remaining candidates.

Step 4: If the above condition is true, then eliminate the current block from the candidate factors and return to step 1 with the updated list of candidates. If the above condition is false, sequentially try m−1, m−2, . . . , 2, 1 until the condition is satisfied (note: it is a mathematical certainty that the condition must be satisfied in the case where only 1 candidate factor is eliminated).

Step 5: Repeat steps 1-4 until all factors remaining has a chisq statistic exceeding a pre-determined threshold.

The net result from Steps 1-5 will be a list of most useful factors with respect to the pre-determined threshold. A lower threshold favors a final model with more factors, and a higher threshold favors fewer factors.

After the final list of factors has been determined, the pre-computed coefficients will be computed and saved along with the model diagnostics.

### III. Price Prediction

Having determined pre-computed coefficients from historical data, it becomes possible to use them in conjunction with data in the database to predict items that are being currently traded. The process for doing so, as described herein, is as follows:

Step 1: Collect user input information regarding the item.

Step 2: Collect relevant information from third party data providers for that item.

Step 3: Replicate factor building process with the information collected in steps 1 and 2.

Step 4: Combine the result in Step 3 with pre-computed coefficients and the price prediction formula to give the final price.

The price prediction formula could differ from market to market. For example, goods and services with high liquidity and trade volume, their price distribution will typically be normal or log-normal. In that case, the prediction formula will simply be a linear combination of the pre-computed coefficients and the factors; or exp( ) of that linear combination. In antiquity auction markets for example, a general price distribution could be much more difficult to determine, and the pricing formula would need to be computed on a market-by-market basis.

### A Second Example Embodiment

In a second example embodiment described herein, systems and methods are described in the context of one or more dedicated computing environments. It should be understood that such an environment is not limiting, and that in other embodiments all or some of the systems and methods may be implemented in a distributed environment. In addition, it should be understood that the systems and methods described in the context of this embodiment may be combined with those of other embodiments.

It should be recognized that in this second example embodiment, a price estimate is provided at a specific timing or epoch for the estimate, i.e., a current (present) time versus a future time or times. Specific trigger events are described, such as a user request for a price estimate, a change or update to underlying data for inter-market and intra-market information, or elapse of a period of time (such as daily or weekly or monthly). Further, specific actions taken in response to the trigger events are described, such as identification of factors of significance, elimination of factors deemed insignificant, estimation of parameters signifying relative importance of the factors, building of the model, and implementation of the model to provide a price estimate. It should therefore be understood that the nature of the epoch for the estimate, the nature of the trigger event or events, and the nature of the calculations and responses undertaken in response to the trigger event are not limiting, and each may be combined with others in this or in other embodiments.

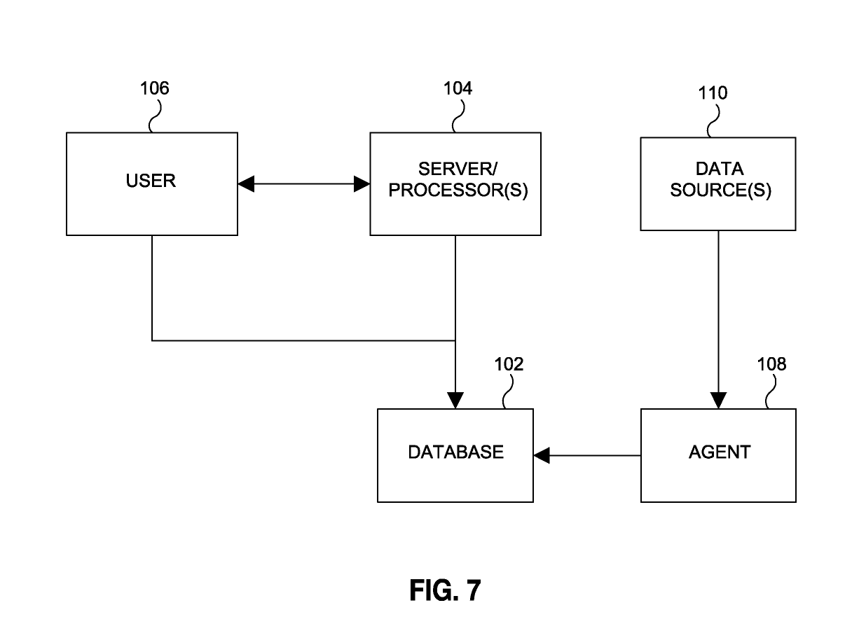

FIG. 7 is a representative view of a fair pricing system 100 including one or more servers 104, a database 102, a user computer 106, and an agent 108 that are relevant to one example embodiment. The server 104 and user computer 106 generally comprise a programmable general purpose personal computer (hereinafter “PC”) having an operating system such as Microsoft® Windows® or Apple® Mac OS® or LINUX, and which is programmed as described below so as to perform particular functions and in effect to become special purpose computers when performing these functions. The user computer 106 and the server 104 include, respectively, a monitor including a display screen, a keyboard for entering text data and user commands, and a pointing device. Pointing device preferably comprises a mouse for pointing and for manipulating objects displayed on the display screen. Although FIG. 7 shows server computer 104 as a single unit, it will be appreciated that the server 104 can actually be comprised of multiple computers and or processors arranged as a distributed network.

User computer 106 and server 104 also include computer-readable memory media such as a computer hard disk and a DVD disk drive, which are constructed to store computer-readable information such as computer-executable process steps. The DVD disk drive provides a means whereby the host computer can access information, such as image data, computer-executable process steps, application programs, etc. stored on removable memory media. In an alternative, information can also be retrieved through other computer-readable media such as a USB storage device connected to a USB port, or through a network interface. Other devices for accessing information stored on removable or remote media may also be provided.

The user computer 106 may acquire a fair price determination from the server 104 via a network interface and may transmit information acquired from a user of the computer 106 to database 102. Likewise, server computer 104 may interface with the user computer 106 to receive a request for a fair price determination of a commodity stored in the database 102 and may interface with the database 102 to transmit and receive pricing information for the commodity requested.

Database 102 includes information related to a plurality of commodities and inter-market and intra-market information, described below. Agents 108 collect external data from a plurality of third-party, external data sources 110, which can be pre-designated and changed over time. The agents 108 examine data from the data sources 110 and collect meaningful information used to input to the database 102.

The agents 108 can search the Internet automatically to collect data from the pre-designated collection of data sources 110 of interest. Preferably, the searching of the Internet by the agents 108 is continuous to keep up to date with the external data sources 110, most of which are not static. For example, classified advertisements in newspapers change frequently, as do prices reflected in Internet data sources such as Amazon™ and eBay™.

In addition, over time, some of data sources 110 may become less significant, while other data sources can become more significant. The pre-designated collection of external data sources 110 can be updated over time, such as by the computerized agents 108, and preferably at timings with regard to the integrity and value of the data that contributes to the database 102 from which the calculations described below are made. Newly-identified data sources are introduced into the pre-designated collection of data sources 110 for searching in future cycles by the agents 108.

The database 102 comprises commodities and price histories for such commodities, together with information potentially meaningful to the pricing of the commodities. The server 104 identifies correlations in the database 102 and discovers previously-unknown correlations amongst entries in the database 102. The server 104 can receive a trigger, such as pricing request from the user computer for a fair price determination of a commodity in the database 102.

The server 104 identifies candidate factors from the data in the database 102 for modeling the price requested by the user computer 106. The server 104 builds a pricing model using the final candidate factors and generates a fair price using the pricing model and information in the database 102. The server 104 transmits the fair price to the user computer 106.

In one embodiment, not shown in FIG. 7, data related to a user's interaction with the user computer 106 is input to the database 102. For example, the user 106 might request prices for multiple items considered alternatives to each other, and might submit request for price over a period of time. If the user is using the system 100 to make a purchasing decision, the choices rejected by the user in leading to his or her ultimate purchasing decision can be incorporated into the information in the database 102 and in the model that is built, such as by incorporation of a discrete choice model.

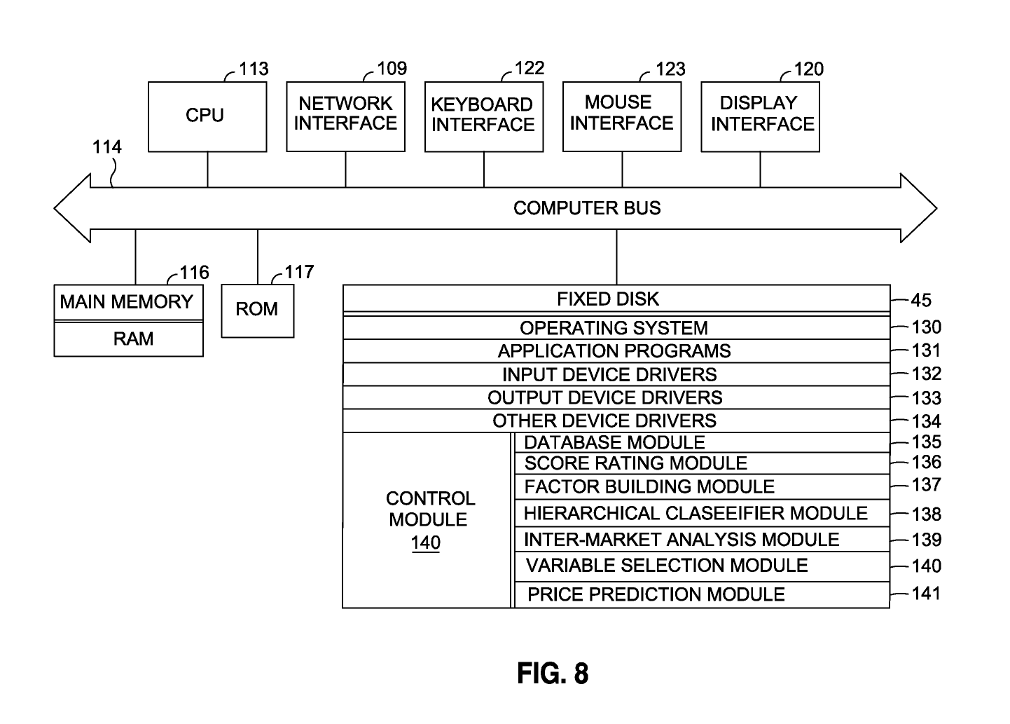

FIG. 8 is a detailed block diagram showing the internal architecture of server 104. As shown in FIG. 8, server 104 includes central processing unit (CPU) 113 which may be a multi-core CPU and which interfaces with computer bus 114. Also interfacing with computer bus 114 are fixed disk 45, network interface 109, random access memory (RAM) 116 for use as a main run-time transient memory, read only memory (ROM) 117, DVD disk interface 119, display interface 120 for a monitor, keyboard interface 122 for a keyboard, mouse interface 123 for a pointing device. RAM 116 interfaces with computer bus 114 so as to provide information stored in RAM 116 to CPU 113 during execution of the instructions in software programs such as an operating system, application programs, control modules, and device drivers. More specifically, CPU 113 first loads computer-executable process steps from fixed disk 45, or another storage device into a region of RAM 116. CPU 113 can then execute the stored process steps from RAM 116 in order to execute the loaded computer-executable process steps. Data such as commodity price or other information can be stored in RAM 116, so that the data can be accessed by CPU 113 during the execution of computer-executable software programs, to the extent that such software programs have a need to access and/or modify the data.

As also shown in FIG. 8, fixed disk 45 stores computer-executable process steps for operating system 130, and application programs 131, such as fair pricing model programs. Fixed disk 45 also stores computer-executable process steps for device drivers for software interface to devices, such as input device drivers 132, output device drivers 133, and other device drivers 134. Pricing files (not shown) are available for output to database 102 and user computer 106 and for manipulation by application programs.

Control module 145 comprises computer-executable process steps executed by a computer for control of the fair pricing system 100. Control module 145 controls the fair pricing system 100 such that a requested fair price of a commodity is generated and output to the user computer 106. Briefly, control module 145 controls the server 104 so that correlations among data in the database 102 are identified. A trigger, such as pricing request from the user computer 106 is received for a fair price determination of a commodity in the database 102. Candidate factors from the data in the database 102 are identified for modeling the price requested by the user computer 106. A pricing model is built using the final candidate factors and a fair price is generated using the pricing model and information in the database 102. The fair price is transmitted to the user computer 106.

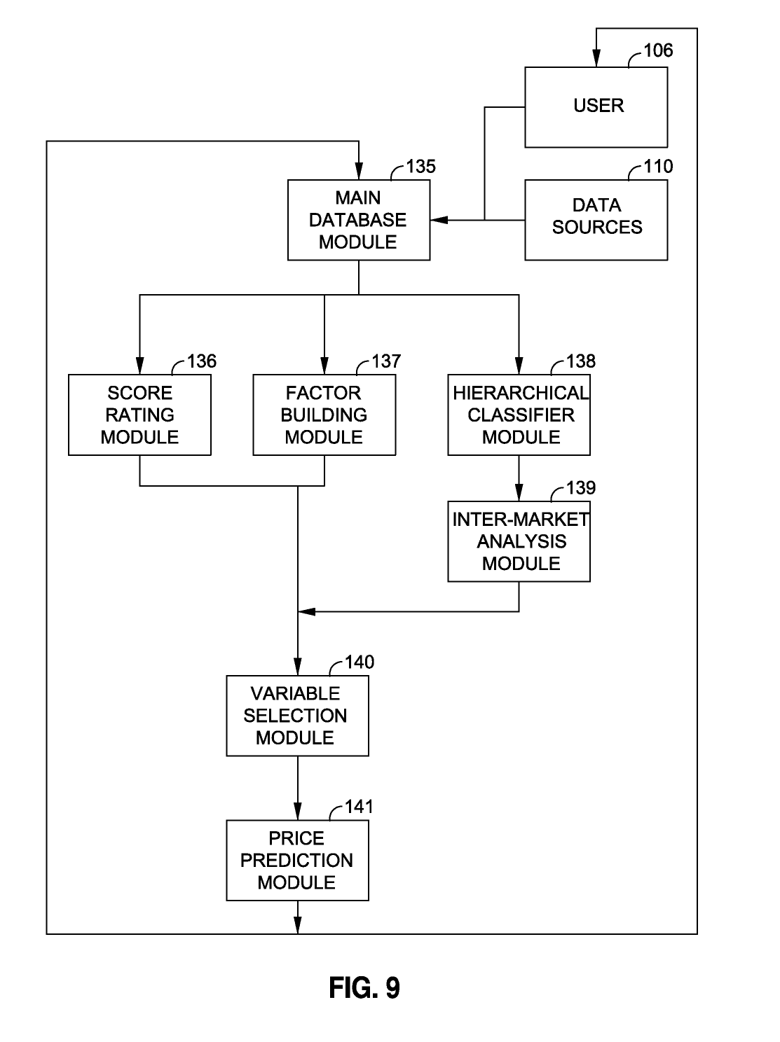

As shown in FIGS. 8 and 9, control module 145 includes, at least, computer-executable process steps for plural modules of this embodiment, including database module 135, score rating module 136, factor building module 137, hierarchical classifier module 138, inter-market analysis module 139, variable selection module 140 and price prediction module 141.

Database module 135 is constructed to manage the data in the database 102. Main database module receives user information and a fair price request from the user computer 106. The fair price module 135 combines the user information with information from public sources received by the database module 135. The database module 135 also receives and stores in the database pricing prediction information generated from price prediction module 141. The database module 135 temporarily stores user input data along with any information from public sources used to update the data in the database.

The database module 135 compares the information stored in the database 102 against the information input by the user and public sources to check the validity of the user and public source information. The database module 135 updates the database 102 with information that is temporarily stored after the database module 135 validates that the temporarily stored information meets the requirements of a data filter, described below. The information in the database 102 is checked for missing or unreasonable records, and statistical tools are used to determine which records are to be removed from the database 102. For example, in the embodiment shown in FIG. 7, the database module 135 can cross-check third party data sources 110 against information input by the user computer 106. The database module 135 also updates the database 102 with outputted price predictions from the price prediction module 141.

Score rating module 136 is constructed to identify mini-models of pricing factors, hereinafter referred to as “score ratings” that may affect the requested price of a good or service. The score ratings identified by the score rating module 136 may be those score ratings that are correlated with the price of the commodity in the user's request or other commodities in the database 102. Statistical correlation tools can be employed to determine the strength of the correlations between the score ratings and the price of the commodities. Coefficients of the score rating's mini-model factors can be determined by maximum likelihood, Bayesian estimation or curve and surface fitting, such as splines.

Factor building module 137 is constructed to identify measurable factors in the database 102 that may affect the requested price of the commodity. The factors identified by the factor building module 137 may be those factors that are correlated with the price of the commodity in the user's request or other commodities in the database 102. Statistical correlation tools can be employed to determine the strength of the correlations between factors and the price of the commodities.

Hierarchical classifier module 138 is constructed to classify each item of information in the database 102 into a hierarchical tree structure. At the top of the structure is general information, which may relate to different markets, and which affects information at lower levels of the structure, which may relate only to the underlying commodity whose price is requested. Multiple hierarchical structures can overlay one another. A hierarchical classifier is associated with each factor and score rating. The hierarchical classifier can be turned on or off at the various levels in the tree structure based on whether the information is relevant to the price of the commodity whose price has been requested.

Intermarket analysis module 139 is constructed to generate inter-market correlations from the hierarchical classification of the hierarchical classification module. In so doing, relationships across commodity markets that may impact the pricing of a commodity can be observed.

Variable selection module 140 amalgamates the factors from the factor building module 137, the score ratings from the score rating module 139, and the intermarket information from the intermarket analysis module and distills the information into a set of candidate factors for building a preliminary model for the requested price of the commodity. The variable selection module 140 outputs a list of the most statistically relevant factors with respect to a pre-determined threshold for statistical significance. A lower threshold favors a final model with more factors, while a higher threshold favors fewer factors. The variable selection module 140 computes regression coefficients for the modeled factors based on historical information and also computes diagnostic parameters related to the model. The variable selection module 140 outputs a pricing formula based on the computed regression coefficients.

Price prediction module 141 checks for and updates any updated public and user input information to update the coefficients and the candidate factors determined by the variable selection module 140 before using the updated price prediction formula to output a fair price for the commodity.

The computer-executable process steps for control module 145 may be configured as a part of operating system 130, as part of an output device driver such as a display or printer driver, or as a stand-alone application program such as a fair price prediction system. They may also be configured as a plug-in or dynamic link library (DLL) to the operating system, device driver or application program. For example, control module 145 according to example embodiments may be incorporated in an output device driver for execution in a computing device, such as a display driver, embedded in the firmware of an output device, such as a display screen, or provided in a stand-alone application for use on a general purpose computer. In one example embodiment, control module 145 is incorporated directly into the operating system for general purpose host computer 40. It can be appreciated that the present disclosure is not limited to these embodiments and that the disclosed control module may be used in other environments in which control of a fair pricing system is desired.

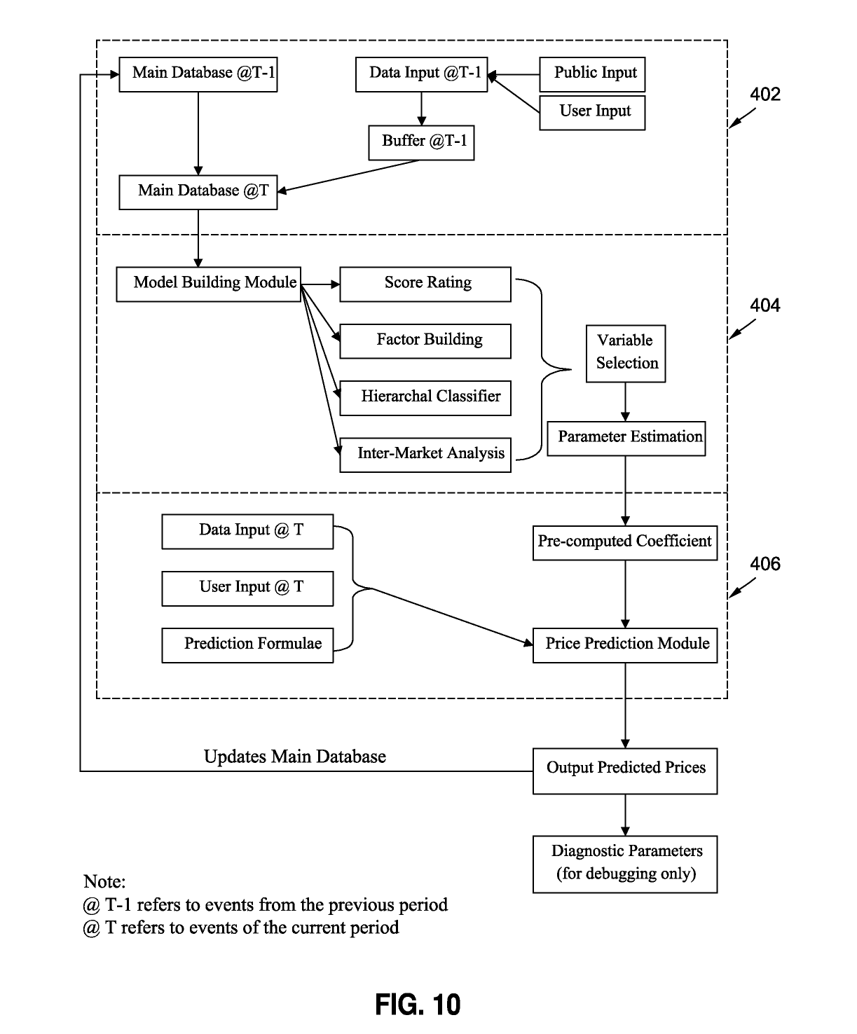

As discussed briefly above, the price of a commodity will be determined in generally three steps, shown diagrammatically in FIG. 10: database collection and organization 402; model building 404; and price prediction 406. The three steps are shown in FIG. 10 with reference to the modules described above with reference to FIGS. 8 and 9. FIG. 10 shows a time progression from a time period at T−1 to a subsequent period at time T. Time T refers to the events of the current period, which will be taken to correspond to the period in which a price request is sent. Time T−1 refers to the period preceding the current period.

The price prediction model described herein is built from data stored in the main database 102, which can be populated with publically/commercially available information from external sources of information 110. Such publically/commercially available information includes historical price information for commodity whose price is to be predicted by the system 100. The price prediction model can also be built using information supplied by the user 106, described in further detail below.

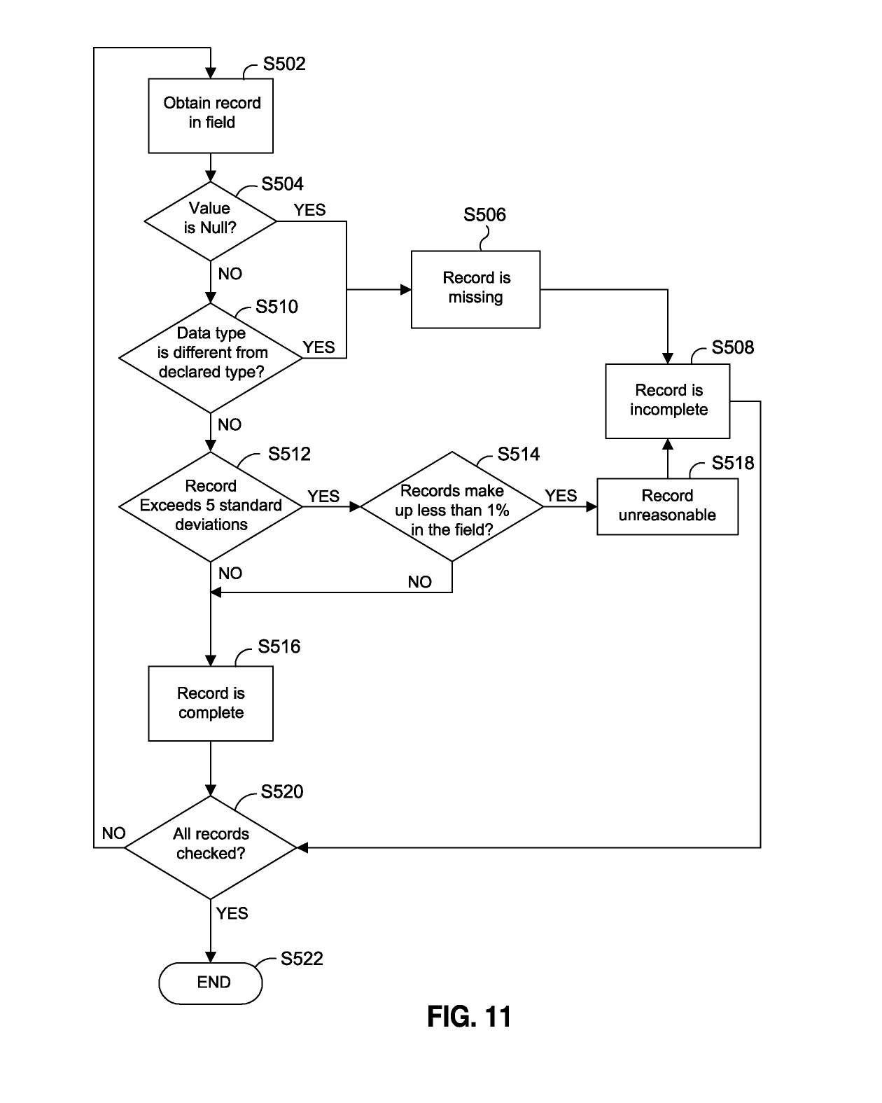

As shown in FIG. 11, in period T, the current state of the database 102 is updated from the previous period (at time T−1) with information received from public sources and from the user. The information received by the database module 135 in period (at time T) is stored in a buffer that previously stored information during period T−1.

The system and method obtains “current factors” from the user and “primary factors” from third party sources to determine the contributions of the current factors and primary factors to the requested price.

The user may provide the current factors to the database through user interaction with the system, such as when a user inputs a search query for a price of a good or service or when the user transacts for the good or service. Current factors may include, for example, information individualized to the user, generalized user information, or feedback obtained from sources independent of the user, such as feedback describing purchases ultimately made by the user, particularly purchases made in reliance on the estimate of fair price provided to the user by the system herein. In this regard, discrete choice models may be employed, using such feedback, and thus incorporating the additional information provided by knowledge of the choices rejected by a user along the path to the user's ultimate purchase decision. For example, the prices requested by a user, particularly of alternative items, are also important especially insofar as other choices not selected by the user.

Of course, it is to be understood that user input of data to the database 102 need not imply manual input of such data. The user 106 can be provided with the option to consent to providing their data input. In one embodiment, the user 106 is asked for his authorization before the data input by the user is saved in the buffer. Consent is optional and, therefore, does not affect whether the system 100 generates a fair price for the commodity. Where the user's consent is given, his or her input data is temporarily saved in the buffer. The user input information can include information specific to the commodity whose price is to be determined. The data input to the database 102 by the user 106 can also include information specific to the market in which the commodity is marketed.

The primary factors relate to the price of a good or service and include those factors obtained from sources other than the user, such as online marketplaces that track historical pricing of commodities. Examples of sources 110 of public/commercially available data include Google™, Amazon™, Ebay™, etc. The more useful data sources 110 are those that provide a historical database of traded prices for the good or service to be modeled and/or provide an automated update of such pricing information such as an electronic arrangement using the Internet (e.g., through an API). In the database 102, commodities are organized by market and factors that may be related to the pricing of the commodities are also stored in the database 102.

The information received in period T by database module 135 that is temporarily saved in the buffer, can be filtered and cleaned for invalid or incomplete entries (or entries that require other special treatment) prior to being incorporated into the main database 102. User information and public information received by the database module 135 may be incomplete or erroneous, and, therefore, the database module 135 checks the integrity of the information before being stored in the database 102. By way of an example, a user who provides data to the system may be a buyer or seller of a good or service. If the user becomes an eventual buyer or seller of the good or service being modeled, his or her action of purchase or sale may be recorded by a third party data provider. Such sale information can be used to verify the validity of the data in the database 102.

For example, a user buying a book on Amazon.com may enter relevant details about that book using Amazon.com's website, before making their purchase. When the purchase is eventually made, information from the Amazon.com book transaction can be used to compare against information stored in the database 102 to verify the validity of the data stored therein.

If transaction data from data source 110 does not match with data in the database 102, then the mismatch may indicate a problem with the data of either the third-party or the data in database 102. For example, the data source 110 could be unreliable for the good or service transacted, in which case, the data collected will provide an indication that correction by the data source 110 is required. Also, the data mismatch may indicate that the data entered into the database 102 by the user may be invalid, in which case the system 100 will provide feedback to the user to verify their input so as to improve the reliability of the system 100 for future price estimations.

Data in the database 102 can be periodically overwritten using data in the buffer. However, to protect the data in the database 102 from being overwritten with incomplete entries, in at least one embodiment, before the database 102 from the prior period T−1 is updated during period T with the information in the buffer, the following conditions must ordinarily be met: the duration since the last update is greater than or equal to the recommended duration computed by the model; and the pre-update content in the buffer meets the requirement of a data filter, discussed below.

The data filter detects missing values and error data types (e.g., “.” for traded price) and values beyond reasonable means in the data in the buffer (e.g., $10,000 for a cup of coffee is unreasonable). Since the data quality for one market will likely be different from another market, the treatment for missing or error values will be based on each market.

A complete record is a record in a data table, where every field of that record is present and is deemed to be reasonable. A complete field is a field in a data table, where every record of that field is present and is reasonable. A record in a particular field will be deemed to be missing if that record holds the value that is reserved for “Null” in that field and/or the data type is different to what was declared (e.g., when the amount paid should be a numeric, but a character string is observed). In one embodiment, a record in a particular field will be deemed to be unreasonable if that record exceeds five standard deviations of the mean of that field and those records that exceed five standard deviations make up less than one percent of the records in that field.

A determination of the completeness of a record is shown in the flowchart in FIG. 11. At S502, a record in a data field is obtained from the buffer. At S504 the value of the record is checked. If the value of the record is null (YES at S504), then a determination is made that the record is missing (S506) and is incomplete (S508). Otherwise, if the value of record is not null (NO at S504), then a further determination is made at S510 of whether the data type is different from a declared data type. If the data type is different from the declared data type for the field (YES at S510), then the record is missing (S506) and is incomplete (S508). If the data type is not different from the declared data type for the field (NO at S510), then it is further determined at S512 whether the record differs from the field by more than five standard deviations. If the record does not differ from the field by more than five standard deviations (NO at S512), then the record is complete. If the record differs from the field by more than five standard deviations (YES at S512), then it is further determined at S514 whether those records that exceed five standard deviations make up less than one percent of the records in that field. If those records that exceed five standard deviations do not make up less than one percent of the records in that field (NO at S514), then the record is complete S516. Otherwise, if those records that exceed five standard deviations do make up less than one percent of the records in that field (YES at S514), then the record is unreasonable S518 and the record is incomplete S508. Whether the record is complete or incomplete, at S520 it is checked whether or not all of the records have been checked. If all records have been checked (YES at S520), then the process ends at S522. Otherwise, if all records have not been checked (NO at S520), then the process proceeds to obtain a record in a field at S502.

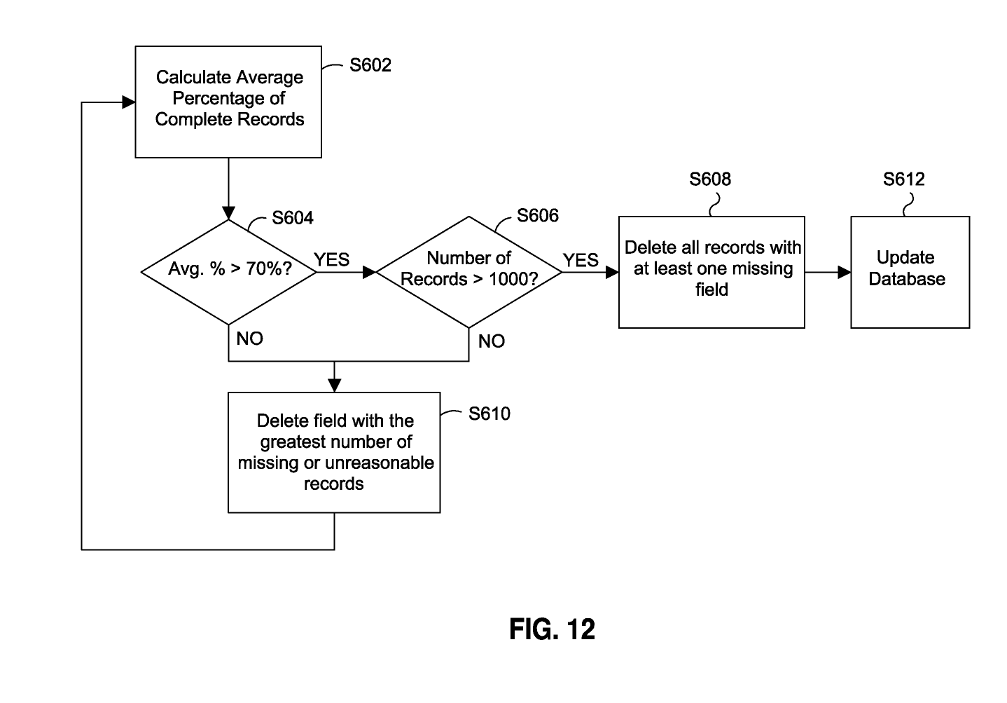

A process for deleting incomplete records from the buffer is described with reference to the flow chart shown in FIG. 12. For each market, the average percentage of complete records is calculated at S602. At S604 it is determined whether the average percentage of complete records exceeds 70%. If the average percentage of complete records does not exceed 70% (NO at S604), then the field with the greatest number of missing or unreasonable records is deleted at S610. Otherwise, if the average percentage of complete records exceeds 70% (YES at S604), then it is determined at S606 whether or not the number of complete records exceeds 1000. If the number of complete records exceeds 1000 (YES at S606), then all records with at least one missing field are deleted at S608 and the database is updated at S612. Otherwise, if the number of complete records does not exceed 1000 (NO at S606), then the field with the greatest number of missing or unreasonable records is deleted at S610.

As discussed above, data in the database 102 is used in a model building process 404 (FIG. 10) to build a pricing model for a good or service, whose fair price (or price range), Y, is to be determined. The pricing model will include factors and regression coefficients for a pricing formula, described in greater detail hereinbelow. The pricing model will also have associated with it a set of model diagnostic parameters related to the statistical “goodness” of the model.

In one embodiment, the pricing model is built in response to a trigger. The trigger for building the model may include a pricing request from the user received by server 104 during period T. Based on the model, and in response to the user request for a price, an estimate is made of the price or price range of the commodity requested by the user, and the estimate is returned to the user (as described below). Although a trigger is used to initiate the building of a model, a trigger is not required to determine when a pricing model is calculated. The pricing model can, for example, be calculated in advance and used later after receiving a price request.

Another example of a trigger is the expiration of a time interval, wherein the time interval is a time interval whose length carries an expectation that there might be non-negligible changes in the candidate factors determined by the variable selection module 140. The time interval might be short or long depending on the nature of the commodity. For example, in the case of a commodity involving the price of an actively traded stock, the time interval might only be a few seconds. In the case of a commodity involving of a relatively stable commodity, such as the price of a widely-available device, the time interval might be a week or even a month. In the case of a commodity such as a newly-introduced electronic device, the time interval might be a few hours of a few days.

In general, the model building process 404 can be viewed as including three steps: summarizing intra-market (item specific) information (score rating and factor building); summarizing inter-market information (inter-market analysis and hierarchal classifier); and selecting pricing model variables (distilling the intra-market and inter-market information). As noted above, the score rating module 136 generates score ratings, the factor building module 137 generates factors, the hierarchical classifier module 138 classifies the information in database 102 among various hierarchical levels and markets, the intermarket analysis module 139 analyzes the inter-market information, and the variable selection module 140 selects the pricing model variables.

In one aspect, the price prediction system 100 described herein differs from conventional pricing systems in that both intra-market (item specific) and inter-market (cross-market) factors that affect the price of the commodity are used in the pricing model. As already discussed above, current factors can be input by users and primary factors can be input by data sources 110. The current and primary factors include intra-market information that is specific to the item.

The intra-market factors used in the pricing model are those quantities that are correlated to the price of the good or service whose price is requested. For example, let X and Y be two random variables defined on the same probability space (Omega, F, P), and further assume that both X and Y are square integrable with respect to P (by the Cauchy-Schwarz inequality), which implies that the product XY is also integrable. A correlation coefficient between X and Y is defined as: (E(XY)−E(X)E(Y))/(stdev(X)stdev(Y)), where E( ) and stdev( ) are the expectation and the standard deviation of the underlying random variable, respectively. The assumption that the random variables are square integrable, along with the Cauchy-Schwarz inequality, guarantee the integrity of the above calculation.

If the correlation between X and Y is positive, then X and Y are statistically more likely to move in the same direction. If the correlation between X and Y is 0 (or statistically insignificant from 0), then X and Y are statistically more likely to be linearly independent of each other. If the correlation between X and Y is negative, then the movements of X and Y are statistically more likely to oppose each other. The absolute value of the correlation coefficient, which ranges between −1 and 1, indicates the strength of the correlation relationship between X and Y.

In reference to the term “cross-correlations”, it should be recognized that in the most mathematically rigorous interpretation, a correlation is a numerical quantity determined by formula, such as the formula given above. The mathematical properties of that formula only describe the linear interaction between the underlying random variables. The process described herein uses correlations, and may further use other and more sophisticated metrics (e.g. graphical models) to model the interaction of prices between different commodities. Thus, in many implementations, interactions beyond simply linear interactions are modeled. It should further be recognized that the word “correlation” is often taken to refer to the coefficient of a parametric model. Use of the word “correlation” in this disclosure sometimes refers to somewhat broader notions; for example, under a maximum likelihood framework, the regression coefficient around a neighborhood of epsilon radius (for a small enough epsilon) does indeed behave like the correlation between the underlying factor Xi and the response variable Y. The meaning of the word “correlation” will be understood from the nature of its usage.

Factor building and score rating are included in a general regression framework employed in the model building process 404 described herein, where a response variable Y is modeled by a number of factors X1, X2, . . . , Xn. For example, the variable Y can represent the price of a car, while factors X1, X2, . . . , Xn, can represent factors that affect price of the car, such as, for example, the prices of various raw materials such as steel, plastic, glass, and copper. Non-limiting examples of regression models include models that are polynomial (including linear), geometric, exponential, log-linear, log-log, and the like, and combinations thereof.

A factor, Xn, is a number that is either directly measurable, or a simple arithmetic of one or more directly measurable quantities. An example of a factor is the average house sales price in the last six month. A factor Xi is termed a “built factor” if Xi can be directly computed from input data, rather than from a model of other factors. The factor building module 137 determines factors correlated to the price of the good or service that is the subject of the user's pricing request.

On the other hand, if Xi is based on other factors (i.e., is the output of a sub-model of other factors), then Xi is termed a score-rating. A score rating is itself a mini-model of factors Xi, and is algorithmically determined by much more subtle quantities that are, ultimately, directly measurable. An example of a score rating is the competitiveness of the economy, which can have a rating of 0 to 10. Such an exemplary score rating will most likely be based on a regression model of its own, including factors and/or other score ratings. For example, for the score rating of the competitiveness of the economy can be based on factors such as the Dow Jones Industrial Average, level of unemployment, percentage of growth and risk rating. The Dow Jones Industrial Average, level of unemployment, percentage of growth are obviously directly measurable, while the risk rating will be another mini-model, based on its own factors and/or score ratings. Eventually, all of the score ratings will be defined by quantities that are directly measurable. The score rating module 136 determines score ratings correlated to the price of the good or service that is the subject of the user's pricing request.

The score rating module 136 determines score rating coefficients for the mini-model that comprises the score rating. Methods employed by the score rating module to determine the score rating coefficients include: maximum likelihood (this includes the method of least squares); Bayesian estimation; and curve and surface fitting methods, such as splines. These three methods are completely deterministic and algorithmic, with the possible exception of Bayesian estimation, assuming that Monte Carlo Markov Chain is required. However, even if Monte Carlo Markov Chain is required, the method retains its automatic and algorithmic nature and the result is random, while the margin of error can be easily controlled by adding extra Monte Carlo trials.

Intra-market data in the database 102 pertains specifically to the good or service whose price is being modeled. For example, in the pricing for second hand cars, factors such as year, make, model, engine, etc. are applicable primarily to second hand cars, and are otherwise meaningless with respect to other markets.

On the other hand inter-market data refers to information that is relevant across multiple markets, and may include things like state of the economy, average income, location, etc. In the example of second hand car pricing, inter-market data may be used to determine second hard car prices, as well as a variety of other things such as home sale prices.

For example, consider the correlation between home prices and prices of retail shopping. As compared to less affluent suburbs, in more affluent suburbs, it is likely that there will more expensive shops, cafés and restaurants. Such inter-market data in the database can be used with intra-market data to more accurately model the price of real estate in the surrounding area of the affluent suburbs in question.

Another example of inter-market data could be the correlation between “average” airline prices and hotel prices of a destination city. Namely, if the average airline price at a certain date, to New York say, is statistically higher than average, this is an indicator that more than average number of people are travelling to New York on that day. Hence, if on average New York hotel prices remain the same, then it can be surmised that the rooms are underpriced.

To identify inter-market data, the hierarchical data classifier module 138 classifies information in the database 102, which is organized by market, into a hierarchical tree structure. At the top of the structure are general quantities (factors/score ratings) that affect information classified in all lower levels below those quantities. At the bottom of the hierarchical tree structure are very specific quantities that may only affect the underlying good or service to whose price is to be modeled. Multiple hierarchical structures can overlay one another.

The hierarchical classier module 138 assigns a classifier to the factors/score ratings identified by the factor building module 137 and the score building module 136. The hierarchical classifier is often valued as a 0 or 1 (or on/off) variable that determines if the corresponding factor/score rating should or should not be included as a candidate factor in a pricing model for modeling the price of the good or service under consideration. The value of the hierarchical classifier can be determined by data, model, and sometimes by user input.

For example, for real estate pricing, quantities such as state of the economy, will sit on top of the hierarchal structure. While moving down each level, the quantities get more specific. At the next level down, there might be two hierarchal structures overlaying one another, such as: type of property (e.g., Apartment, Townhouse, House, or Rural); and city or suburb. The organization of the tree structure will help identify cross-market interaction between information. For example, a quantity (i.e., a factor or score rating) that measures the state of the economy of a given city or suburb can impact a home price in the city or suburb as well as help to predict the premium added for retail products sold in that city or suburb. The score rating that measures the state of the economy of a given city or suburb could be a mini-model which uses past sales data of house price and/or price of retail items in that city or suburb.

For example, it is expected that factors and score ratings designed specifically for one industry (e.g., the food industry), will have very little to do with pricing of commodities in another industry (e.g., antiquities). Thus, in one example, the data classifiers can be yes (1) or no (0), representing whether a product is or is not a product of a certain industry. Thus, when building a pricing model for commodities in the food industry, factors specific for the antiquities industry will likely be classified as not being relevant, i.e., “0” in the example.

At an opposite end of the spectrum, some factors and score ratings are so pervasive that they matter to almost every product at every geographical location during every phase of the business cycle. One example is the price on offer for that product, of which its regression coefficient is termed the “price elasticity”.

Also, in between the aforementioned examples of unrelated factors and pervasive inter-market factors, are factors and score ratings which matter to some, but not all, markets in which the good or service exists, in which case the method described herein can be used to filter factors to be excluded from a pricing model, beginning from the very general to the very specific.

With the information in the database classified by the hierarchical classifier module 138, the intermarket analysis module 139 analyzes correlations between the price of the good or service and the factors/score ratings turned on by the hierarchical classifier module 138 across the various levels of the hierarchy. The correlated factors/score ratings that are not related directly to the market of the good or service are identified as inter-market factors and are used by the variable selection module 140 in determining candidate factors for a pricing model.

One risk of modeling with inter-market factors is what is sometimes termed “spurious correlation”. This occurs when numerical correlation arises in data without regarding the underlying causality in the context, giving rise to completely nonsensical conclusions. An example such spurious correlation would be if ice cream sales were highest when the rate of drowning in the city swimming pool is highest. The hierarchal classification of inter-market factors is suited to mitigate the risk of spurious correlation. Nonetheless, even if a spurious factor is identified as an inter-market candidate factor for use in building the model, with very high probability, it will make a very small contribution to the overall prediction, as other candidate factors would dilute out its significance.

In some embodiments, the hierarchal classifier module 138 can employ an algorithm to set the hierarchical classifiers on and off. Machine learning algorithms such as support vector machines, link analysis and cluster analysis can be used in certain circumstances.

In some circumstances, however, human intervention, such as through user computer 106, may be desirable for setting the hierarchical classifiers. For example, referring to a real-estate example in Australia, a thorough search using cluster analysis or support vector machines may help to identify Point Piper to be a much more affluent suburb than Penrith. Link analysis may help to rank each measurement or rating from most common to most specific, and thereby establishing a hierarchal structure from that. However, more subtle information, such as an identification of those parts of a particular street that might be particularly unpleasant to live in, may be difficult to discover purely by algorithm. A human being on the other hand, only needs to drive by to identify those parts of the street that are not desirable. In a counterpart example of real-estate in the United States, a thorough search using cluster analysis or support vector machines may help to identify Georgetown to be a much more affluent area than other parts of Washington, D.C. Link analysis may help to rank each measurement or rating from most common to most specific, and thereby establishing a hierarchal structure from that. However, more subtle information, such as an identification of those parts of a particular street that might be particularly pleasant to live in, despite being in a less-affluent neighborhood, will be very difficult to discover purely by algorithm. A human being on the other hand, only needs to drive by to identify those parts of a particular street that might be particularly pleasant to live in.

Theoretically, with a large enough database of user input data, the hierarchical classification can be increasingly automated. However, in at least one embodiment, user input and intervention in arranging the hierarchical structure and setting the classifiers is optional, and the degree of permitted user intervention can be adjusted.

Intra-market factors obtained from the factor building module 137 and the score rating module 136 are summarized and used as an input for the variable selection module 140. Inter-market factors obtained from the hierarchical classifier module 138 and the intermarket analysis module 139 is summarized and used as an input for the variable selection module 140. As noted above, the variable selection module 140 determines the factors/score ratings for a pricing formula for Y, which represents the price of the good or service to be predicted by the model. The intra- and inter-market factors used will be candidate factors that may or may not remain in a pricing model determined by the variable selection module 140.

Although the foregoing discussion describes specifically the obtaining of information in the database correlated to a single commodity that is the subject of a user pricing requested, it should be noted that in at least one embodiment, in response to the pricing request correlations between the data in the database and nearly all of the commodities in the database are simultaneously determined to determine pricing for nearly all of the commodities in the database. The simultaneity of the calculations helps ensure that the model used to calculate the price of the commodity requested is up to date.

One issue with regard to variable selection is that, in a model where Y is designated as a determinate and X1, X2, . . . , Xi, . . . , Xn are designated as predictors (e.g., factors), some of the Xi's might or might not be statistically significant enough to be used in the final model of Y. A model with too many redundant factors may not make correct out-of-sample predictions. Eliminating statistically insignificant candidate factors by the variable selection module 140 is one way of identifying an optimal subset of final candidate factors, which will be used in the final pricing model for Y, such that accuracy of out-of-sample predictions can be guaranteed within a certain error range, at a certain predetermined probability. These quantities are called the “prediction interval” and the “significance level”, respectively.

In one aspect, a variable selection algorithm is employed by the variable selection module 140 which can produce as good or better set of final candidate factors than one of the three variable selection algorithms discussed above. In addition, parallelization within the smart variable selection algorithm allows it to run potentially hundreds or thousands times faster than the standard algorithms discussed above on a sufficiently powerful computer or plurality of computers.

The variable selection module 140 identifies which type of price distribution the product to be modeled follows and attempts to eliminate candidate factors that are not significant to predicting the price of the product based on that price distribution. For example, if the variable selection module 140 determines that the price of the product follows a normal distribution, then that module will eliminate candidate factors that are not statistically related to that distribution so as to leave behind final candidate factors that fit the normal distribution.

The formula for calculating the price can be different for each product, because the model structure at the very bottom of each hierarchal structure could be different. The exact nature of the formula(s) should not be limited by the examples provided herein. The price prediction formula can be market dependent. For example, for goods and services with high liquidity and trade volume, their price distribution will typically be normal or log-normal. In that case, the prediction formula will simply be a linear combination of the pre-computed coefficients and the factors; or an exponential function of that linear combination. In contrast, for antiquity auction markets, a general price distribution could be much more difficult to determine, and the pricing formula would need to be computed on a market-by-market basis for each specific antiquity market. Non-limiting examples of pricing formulas follow.

If the price of the final product follows a normal distribution, then the pricing formula is represented as: Y (price)=constant+beta1*X1+beta2*X2+ . . . +betan*Xn. Here, X1, . . . , Xn are the final candidate factors (i.e. after smart variable selection) in the last hierarchal level relating to that product; constant, beta1, . . . , betan are regression coefficients determined by the method of least squares.

If the price of the final product follows a log normal distribution, then the pricing formula is represented as: Y (price)=exp(constant+beta1*X1+beta2*X2+ . . . +betan*Xn). Here, X1, . . . , Xn are the final factors (i.e. after smart variable selection) in the last hierarchal level relating to that product; constant, beta1, . . . , betan are regression coefficients determined by the method of least squares after taking a log-transform.

If the price of the final product follows an exponential dispersion family, and a generalized linear model (GLM) with link function eta is being used (all GLM's have a corresponding link function), then the pricing formula is represented as: Y (price)=eta(constant+beta1*X1+beta2*X2+ . . . +betan*Xn). Here, X1, . . . , Xn are the final factors (i.e. after smart variable selection) in the last hierarchal level relating to that product; constant, beta1, . . . , betan are regression coefficients determined by maximum likelihood.

If the price of the final product follows a mixed linear family with link function eta, then the pricing formula is represented as: Y(price)=int_B eta(constant+beta1*X1+beta2*X2+ . . . +betan*Xn) dF(beta). Here, int_B . . . dF(beta) means to integrate everything in between with respect to the probability distribution F(beta) over the domain B, and where B represents all possible values where the vector (beta1, . . . , betan) can be defined on.

The variable selection module 140, eliminates candidate factors determined to be statistically insignificant for predicting the price Y of the good or service being modeled and outputs a subset of final candidate factors that are determined to be statistically significant (based on a predetermined threshold) and that are included in the final model for Y. Elimination of candidate factors is accomplished through the application of a library of statistical tools, including stepwise selection, backward elimination, as well as others described herein.

Conventional algorithms are known for identifying candidate factors. Such algorithms include forward selection, backward selection and stepwise selection. Any algorithm that is either faster and or “better” than the three standard strategies can be considered to be a “smart algorithm”. It is relatively easy to determine the computational run-time of each algorithm; however it is generally more difficult to determine the “goodness” of the final model to predicting the actual quantity being modeled.

One measurement of interest for modeling is out-of-sample performance (i.e., accuracy in predicting the future), which cannot be done until the future is actually known. Other methods known as “jack knifing”, “bootstrapping” and “cross validation” are all based on the assumption that the future can be “simulated” from within a data sample (e.g., exclude a data point, run the model, and re-predict as if the future was known). There are penalty based measures such as Akaike information criterion and Bayesian information criterion (AIC and BIC), which also measure the “goodness” of a model.

The variable selection module 140 employs a number of algorithms, which include, but are not limited to: 1. Maximum likelihood estimation; 2. Bayesian inference; 3. EM algorithm; 4. Support vector machines; 5. Artificial neural network; and 6. Curve fitting and splines.

The variable selection process used by the variable selection module 140 is considered to be superior to conventional variable selection processes, such as forward selection, backward selection and stepwise selection. Here, superiority is measured by, computational efficiency and value of the Akaike and Bayesian information criterion of the selected model.

The goodness of fit for statistical models is commonly measured by the value of log-likelihood of the model. However, since the log-likelihood value always improves for models with more factors (regardless of whether they are statistically relevant or not), Akaike information criterion and Bayesian information criterion can be used to “penalize” models with too many factors. Namely, they would each set a different tradeoff criterion whereby if the new factor does not improve log-likelihood by a certain threshold, the new model would be regarded as inferior to the model without the new factor.

Since the log-likelihood is at the maximum when all candidate factors, such as all of the intra- and inter-market factors, are in the model, the process described herein will first fit all of the candidate factors to the data distribution identified by the variable selection module 140. The resulting model with the full complement of candidate factors is considered the “full model”. The resulting log-likelihood value is referred to as L_max. Standard backward elimination would test variations of the “full model” by eliminating one individual candidate factor, having the highest p-value, at a time, re-fitting the model to the distribution, and checking the p-value of all of the factors remaining in the model. The process would be repeated until the p-value of all factors are less than a pre-determined number, alpha. The drawback with such a standard backward elimination method is that the process can be very slow, and makes implementing parallel computation on a multi-core CPU very difficult.

The process described herein differs from backward elimination in that more than one candidate factor may be eliminated at a time. Also, such a process differs from backward elimination in that the process is highly parallelizable on a multi-core computer, or on a cluster of distributed servers.

The variable selection algorithm used by the variable selection module 140 exploits the following relationship. The “chisq” (chi-squared) statistic of a candidate factor is its coefficient predictor divided by the standard error of that predictor. If one candidate factor is eliminated from a model, the change in log-likelihood value will be equal to one-half of the candidate factor's chisq statistic. The variable selection module 140 tests models with different pluralities of candidate factors removed and compares the models to identify the model having the best performance.

More specifically, the variable selection module 140 eliminates a plurality of candidate factors from the full model to test the resulting model with the remaining candidate factors. The chisq values of the factors in the resulting model are compared against the chisq values of the factors in the full model (i.e., the model without that plurality of factors removed), in order to measure the total contribution of the plurality of candidate factors that were removed. If the average log-likelihood contribution of the eliminated plurality of candidate factors is less than the minimum chisq value of the remaining candidate factors, and the total change in the log-likelihood is less than a pre-determined threshold, then the plurality of candidate factors is eliminated.

The next issue is the efficient computation of which plurality of candidate factors to eliminate. The variable selection process described herein is highly parallelizable, and hence computation time will be relatively short in comparison to the standard backward elimination, discussed above. The calculations are preferably carried out in parallel, on multiple processors (i.e., “processing nodes”) each operating independently of each other, and each receiving a truncated version of the full model having different numbers of candidate factors removed for testing by each processor. Thus, the truncated models include a subset of the candidate factors.

One or more processors might, in addition, serve as coordination nodes, for coordinating the distribution of such truncated models to parallel processing nodes, and for compositing and analyzing results returned from the processing nodes. In addition, the coordinating nodes might implement an iterative process whereby, upon receipt of intermediate processing results from parallel processing nodes, additional truncated models are distributed in parallel to the processing nodes, whereby the process is iteratively repeated so as to obtain needed correlations and factors, and so as to obtain determinations of final candidate factors.

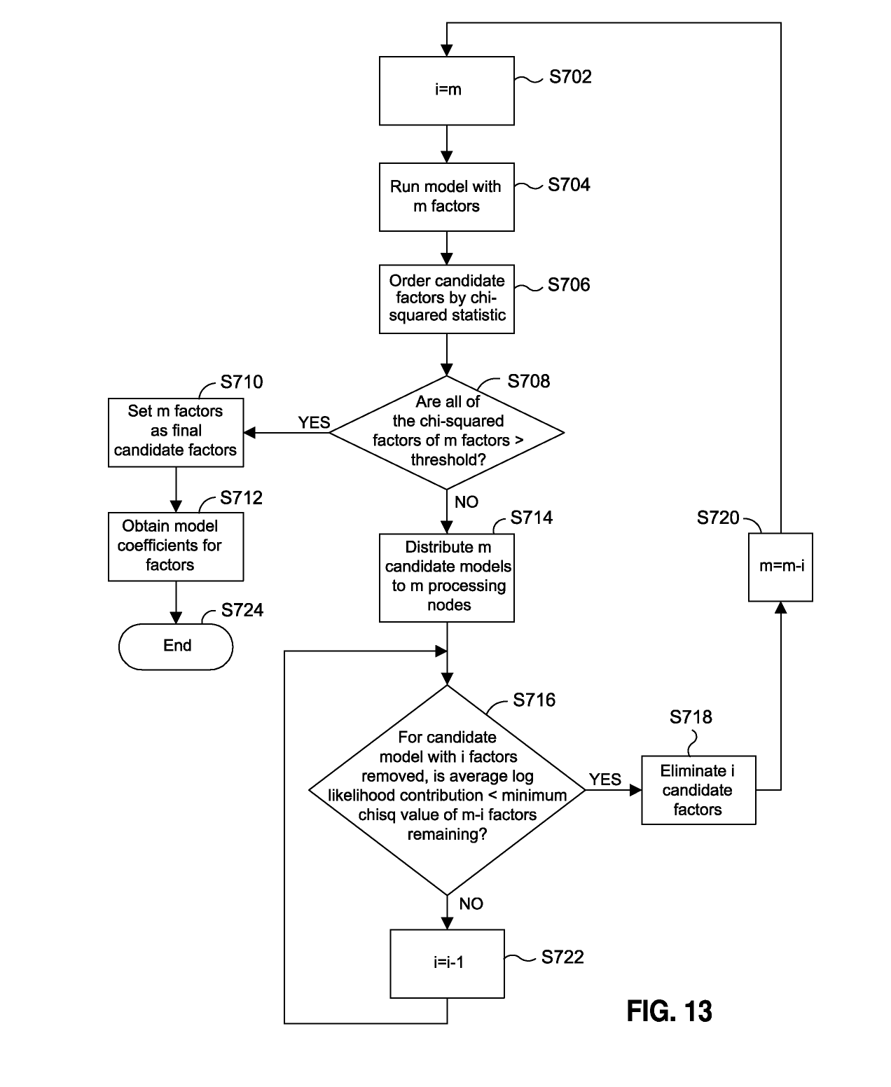

An example of the variable selection process by the variable selection module 140 will now be described with reference to the flow chart shown in FIG. 13. Let m be the total number of candidate factors identified from intra-market and inter-market summarization in the full model, and n be the total number of CPU's available for computation. For example, a laptop computer may have 8 cores, so n=8; while a cluster of supercomputers can have hundreds or thousands cores.

At S702, a counter, “i”, representing the number of candidate factors to be removed, is initialized to m, the total number of candidate factors in the full model. At S704, the full model including m candidate factors is run. At S706, the m candidate factors are ordered by their chisq statistic, from highest to lowest. At S708, if all of the chisq statistics of m candidate factors in the model is greater than a predetermined threshold (YES at S708), then the m factors are set as final candidate factors at S710 and the model coefficients are calculated at S712.

Otherwise, if all of the chisq statistics of m candidate factors is not greater than a predetermined threshold (NO at S708), then at S714, m models are simultaneously distributed to respective cores as follows:

(i) Full model with the candidate factor having the lowest one chisq factor eliminated. (Only one candidate factor eliminated)

(ii) Full model with the two candidate factors having the lowest two chisq factors eliminated. (Only two candidate factors eliminated)

(iii) Full model with the “i” candidate factors having the lowest “i” chisq factors eliminated. (Only “i” candidate factors eliminated)

. . . .

(m) Full model with m candidate factors having the lowest m chisq factors eliminated. (All candidate factors are eliminated).

Starting with the model with greatest number of candidate factors eliminated (i.e., i=m), at S716, it is determined whether the average log-likelihood contribution of the eliminated “i” candidate factors is less than the minimum chisq value of the remaining (m−i) candidate factors. If the average log-likelihood contribution of the eliminated candidate factors is not less than the minimum chisq value of the remaining (m−i) candidates (NO at S716), then “i” is decremented at S722 before the process proceeds back to S716. Thus, each time S716 and S722 are repeated, a truncated model with one less candidate factor is checked. S716 and S722 are repeated until the condition at S716 is satisfied (YES at S716). If the average log-likelihood contribution of the eliminated “i” candidate factors is less than the minimum chisq value of the remaining (m−i) candidate factors (YES at S716), then the “i” candidate factors are eliminated from the model at S718, m is initialized to m−i at S720, and the process returns to S702.

The variable selection process shown in FIG. 13 will result in the identification of a final candidate factors which are the most statistically relevant candidate factors with respect to the pre-determined threshold. A lower threshold favors a final model with more factors, and a higher threshold favors fewer factors.

After the resulting final candidate factors are identified, the variable selection module 140 uses regression analysis, based on historical pricing information in the database 102, to obtain regression coefficients for the final candidate factors in the pricing model. The coefficients and model factors can be stored in the database for use at a later time.

If, at a later time, the user sends a price request to the system 100, the computed coefficients and final candidate factors that have been stored previously are used to generate an updated pricing formula based on updated information from the user 106 and data sources 110. As noted at the outset, the system 100 collects information from the user 106 about the commodity to be priced. Information is also collected from third party sources 110 for the item or service. The user input information and the third party information are used to update the model factors and coefficients with any information from the user 106 or data sources 110. The price estimate is generated using the updated formula and information.

Along with the factors and coefficients for the pricing model, the variable selection module 140 also outputs a collection of system diagnostic parameters. An example of a system diagnostic parameter is the measure of market sensitivity.

Dynamic adjustment is a process which updates the most recent data from the buffer to the model building process 404, re-runs the model, and generates updated regression coefficients for the pricing formula. Dynamic adjustment can be performed according to a schedule. Once the price of the commodity is output by the price prediction module 141, the database module 135 uses the information input by the user 106 in period T, and the information received from data sources 110 in period T, which is stored temporarily in buffer, to cross check the completeness and reasonableness of the input information before updating the data in the database 102 with the information in the buffer. The information in the buffer is combined with data in the main database 102 periodically (e.g. weekly, monthly or annually, depending on the timing sensitivity of the underlying). Therefore, the model building process 404 is somewhat dynamic in that the information from the database 102 that is used to build the model, can be periodically updated from the buffer based on prior model building activity.

Optionally, model diagnostics will be saved along with the model coefficients and factors. Model diagnostics can include standard statistical information regarding the “goodness” of the model compared to historical pricing data. Additionally, the model diagnostics can include information about the estimated accuracy of the determined price.

In at least one aspect, not all or nearly all of the information for the commodities in the database are used for predicting the price of a commodity. Rather, a subset of all commodities is used, such as a subset of commodities comprising commodities determined to have significant correlation or inter-dependencies such that the determination of a price for one commodity is statistically significant and therefore helpful in the determination of the price of another commodity in the subset. Other definitions of suitable subsets of commodities are possible. In addition, it is possible to determine the price only for the commodity requested by the user, without necessarily calculating the price for multiple commodities. In such a case, updating of related or unrelated data may occur as data is narrowed along the way as the price is finally identified. By updating related or unrelated data along the way, the overall updating of increments of data will ordinarily make the calculations more available for subsequent calculations for a requested price.

In implementations where not all or nearly all of the commodities in the database are used directly for predicting a price, information regarding all or nearly all commodities is nevertheless used directly or indirectly in one way or another. As an example, a general parameter such as “generalized state of the economy” may be useful in determining large-scale prices such as the price of a house. However, because that parameter might also indirectly contain or correlate to more particularized information, such as a “retail sector indicator”, the large-scale indicator for “generalized state of the economy” might be helpful in determining smaller-scale prices such as price and/or sales volume of novelties at a local festival.

### OTHER EMBODIMENTS

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the claims directed to the inventive aspects described herein is not limited to the above-described embodiments and that various changes and modifications may be made without departing from the scope of such claims.

This disclosure has been presented for purposes of illustration and description but is not intended to be exhaustive or limiting. Many modifications and variations will be apparent to those of ordinary skill in the art who read and understand this disclosure, and this disclosure is intended to cover any and all adaptations or variations of various embodiments. The example embodiments were chosen and described in order to explain principles and practical application, and to enable others of ordinary skill in the art to understand the nature of the various embodiments. Various modifications as are suited to particular uses are contemplated. Suitable embodiments include all modifications and equivalents of the subject matter described herein, as well as any combination of features or elements of the above-described embodiments, unless otherwise indicated herein or otherwise contraindicated by context or technological compatibility or feasibility.

What is claimed is:

1. A system for determining cross-market correlation factors which contribute to a response to a user request for a price of a commodity, the system comprising:
a database of a plurality of commodities;
a factor determination unit that, responsive to a user request, identifies inter-market and intra-market factors which contribute to a price determination for nearly all of the commodities; and
a factor selection unit that, responsive to the user request, evaluates the contribution of each of the inter-market and intra-market factors to identify candidate factors in a model of the price of the commodity for which a price is requested; and
a price response unit that responds to the request with a price for the asset, good or service based on the model.

2. A method for pricing a commodity, the method comprising:
receiving a request from a user for pricing the commodity;
responsive to receipt of the request, and with respect to a database containing data for prices of commodities together with data for inter-market information and intra-market information relative to such commodities, extracting inter-market and intra-market correlations at least with the price of the commodity in the request;
further in response to the user request, differentiating correlations of significance from the extracted correlations;
calculating candidate factors from the correlations of significance;
predicting a fair price for at least the commodity identified in the user request, by using the calculated candidate factors and the correlations of the significance; and
providing the predicted price for the commodity identified in the user request to the user.

3. The method according to claim 2, wherein during the extracting, inter-market and intra-market correlations are extracted at least with prices of nearly all of the commodities in the database and during the predicting a fair price is predicted for nearly all of the commodities in the database.

4. A method for eliminating non-significant candidate factors from a pricing model for a selected commodity, the method comprising:
calculating cross-correlations in a database which stores data for the prices of commodities including the selected commodity, together with data for inter-market information and intra-market information relative to such commodities;
initializing a full model for the price of the selected commodity, the full model including a plurality of M candidate factors selected based on the calculated cross-correlations;
packaging M test packages of candidate models to be tested, wherein each candidate model comprises the full model with 1 to M factors of lowest significance eliminated;
distributing the M test packages to M processors for execution in parallel, and receiving a test result from each of the M processors, wherein the test result is indicative of the likelihood that 1 to M eliminated factors contribute to the significance of the full model;
in sequence starting from m=1 through m=M eliminated factors, determining if the test result is less than a predetermined threshold likelihood that non-eliminated factors contribute significantly to the model, and selecting the first of such test models in the sequence for which the test result is less than the predetermined threshold;
updating the full model by eliminating the m factors determined to be non-significant; and
repeating the above steps of packaging, distributing, determining, selecting and updating the full model, until all factors not eliminated return a test result exceeding a predetermined threshold of significance.

5. A method according to claim 4, wherein in packaging the test models, factors are eliminated based on those factors having lowest chi-squared factors, and wherein the test result received from each of the M processors comprises an average log-likelihood contribution of the eliminated factors, which is compared against the minimum chi-squared values of the remaining factors.
